(19) United States
(12) Patent Application Publication
(10) Pub. No.: US 2026/0050074 A1
(43) Pub. Date: Feb. 19, 2026

(54) METHODS AND APPARATUS FOR SENSING MULTIPLE ACCESS

(71) Applicant: Huawei Technologies Co., Ltd., Shenzhen (CN)

(72) Inventors: Shahram Shahsavari, Ottawa (CA); Alireza Bayesteh, Brossard (CA); Monirosharieh Vameghestahbanati, Kanata (CA)

(21) Appl. No.: 19/288,683

(22) Filed: Aug. 1, 2025

Related U.S. Application Data
(63) Continuation of application No. PCT/CN2023/074371, filed on Feb. 3, 2023.

(51) Int. Cl. G01S 13/28; G01S 13/32; H04W 84/06

(52) U.S. Cl. CPC G01S 13/28; G01S 13/32; H04W 84/06

(57) ABSTRACT

According to the present disclosure, a transmitter apparatus may transmit a sensing signal comprising an ordered sequence of linear frequency modulated signals (LFMs), in which each of the LFMs in the ordered sequence of LFMs has a slope specified by a corresponding rate in a sensing code. As different transmitter apparatus may be assigned distinct sensing codes, and thus sensing signals, a receiver apparatus can distinguish between sensing signals transmitted by different transmitter apparatus, even if they arrive at the same times and/or frequencies.

### CROSS-REFERENCE TO RELATED APPLICATION

This application is a continuation of International Application No. PCT/CN2023/074371, entitled “METHODS AND APPARATUS FOR SENSING MULTIPLE ACCESS” and filed on Feb. 3, 2023, the disclosure of which is hereby incorporated by reference in its entirety.

### TECHNICAL FIELD

This application relates to sensing and, in particular, to multiple access for sensing.

### BACKGROUND

Various types of sensing are anticipated to be implemented in 6^{th} Generation (6G) wireless systems. In these systems, sensing might not only help to improve the quality of other services such as data communication, but may also be defined as a separate service.

### SUMMARY

Future wireless communication systems are expected to include a network of nodes, in which most of the nodes are capable of performing sensing. However, wireless channels in communications networks are shared media that are resource limited. It can be a challenge to enable sensing services for multiple sensing nodes using the limited number of time-frequency resources that may be available in wireless communication channels.

According to aspects of the disclosure, different transmitter apparatus may be assigned different sensing codes, in which each sensing code includes an ordered sequence of rates. Each transmitter apparatus transmits a respective sensing signal based on its assigned sensing code, in which the sensing signal is formed from an ordered sequence of linear frequency modulated signals (LFMs) having slopes specified by the sensing code. As each transmitter apparatus is assigned a distinct sensing code, and thus sensing signal, a receiver apparatus can distinguish between sensing signals transmitted by different transmitter apparatus, even if they arrive at the same times and/or frequencies. This may reduce the time-frequency resources that are needed to implement sensing. As the number of distinct signals that can be constructed from LFMs is large, this provides a large number of degrees of freedom for multiple access. In addition, LFMs may be processed by low complexity and low power receiver apparatus, which allows a wider range of apparatus to be used to implement sensing.

In an aspect, a method is provided. The method involves obtaining a sensing code and transmitting a sensing signal according to the sensing code. The sensing code includes an ordered sequence of rates. The sensing signal includes an ordered sequence of LFMs. Each of the LFMs in the ordered sequence of LFMs has a slope specified by a corresponding rate in the ordered sequence of rates.

Obtaining the sensing code may involve receiving an indication of the sensing code. Alternatively, obtaining the sensing code may involve selecting the sensing code from a plurality of sensing codes, in which each of the plurality of sensing codes comprises a respective ordered sequence of rates.

The method may also involve receiving an indication of one or more configuration parameters characterizing a construction of the sensing signal based on the ordered sequence of rates. Transmitting the sensing signal according to the sensing code may involve transmitting the sensing signal in accordance with the one or more configuration parameters and the sensing code.

The one or more configuration parameters may include one or more of: a start time of a first LFM in the ordered sequence of LFMs, a starting frequency of at least one LFM in the ordered sequence of LFMs, and a bandwidth of the sensing signal.

The sensing signal may include a repetition of the ordered sequence of LFMs in at least one of: time and frequency. The repetition may be in accordance with a repetition pattern. The one or more configuration parameters may include a characteristic of the repetition pattern.

The method may also involve receiving a signal comprising a reflection of the sensing signal from a first target. The method may also involve determining, based on the received signal and a plurality of sensing codes including the sensing code, a sensing estimate for the first target.

In a further aspect, an apparatus configured to perform the above-mentioned method is also provided. The apparatus may include a processor and a memory (e.g. a non-transitory processor-readable medium). The memory stores instructions (e.g. processor-readable instructions) which, when executed by a processor of an apparatus, cause the apparatus to perform the method above. In another aspect, the memory may be provided (e.g. separate to the apparatus).

In another aspect, another method is provided. The method involves receiving a signal comprising a first sensing signal for a first target. The first sensing signal includes a first ordered sequence of LFMs. The method also involves determining, based on the received signal and a plurality of sensing codes, a first sensing estimate for the first target. A first sensing code in the plurality of sensing codes includes a first ordered sequence of rates. Each of the LFMs in the first ordered sequence of LFMs has a slope specified by a corresponding rate in the first ordered sequence of rates.

Each of the plurality of sensing codes may correspond to a respective transmitter apparatus.

The plurality of sensing codes may also include a second ordered sequence of rates. The received signal may also include a second sensing signal for a second target. The second sensing signal may include a second ordered sequence of LFMs, in which each of the LFMs in the second ordered sequence of LFMs has a slope specified by a corresponding rate in the second ordered sequence of rates. The method may also involve determining, based on the second sensing signal and the plurality of sensing codes, a second sensing estimate for the second target.

The first and second sensing signal may have been transmitted by different transmitter apparatus. Alternatively, the first and second sensing signals may have been transmitted by the same transmitter apparatus, and the first target is different to the second target.

The first sensing signal may have been transmitted by the first target. Determining the first sensing estimate may include identifying the first target based on a detection of the first sensing signal in the received signal, and determining the first sensing estimate based on the identity of the first target. Identifying the first target based on the detection of the first sensing signal in the received signal may involve associating the first sensing code with the first sensing signal in the received signal, and identifying the first target apparatus based on the first sensing code.

The first sensing signal may be received after having been transmitted by a particular transmitter apparatus and reflected by the first target. Determining the first sensing estimate may involve identifying the particular transmitter apparatus based on a detection of the first sensing signal in the received signal, and determining the first sensing estimate based on the identity of the particular transmitter apparatus. Identifying the particular transmitter apparatus based on the detection of the first sensing signal in the received signal may involve associating the first sensing code with the first sensing signal in the received signal, and identifying the particular transmitter apparatus based on the first sensing code.

The method may also involve receiving the plurality of sensing codes.

In a further aspect, an apparatus configured to perform the above-mentioned method is also provided. The apparatus may include a processor and a memory (e.g. a non-transitory processor-readable medium). The memory stores instructions (e.g. processor-readable instructions) which, when executed by a processor of an apparatus, cause the apparatus to perform the method above. In another aspect, the memory may be provided (e.g. separate to the apparatus).

In another aspect, an apparatus is provided. The apparatus includes a processor and a memory. The memory stores instructions which, when executed by the processor, cause the apparatus to obtain a sensing code and transmit a sensing signal according to the sensing code. The sensing code includes an ordered sequence of rates. The sensing signal includes an ordered sequence of LFMs, in which each of the LFMs in the ordered sequence of LFMs has a slope specified by a corresponding rate in the ordered sequence of rates.

The apparatus may be caused to obtain the sensing code by receiving an indication of the sensing code.

The apparatus may be caused to obtain the sensing code by selecting the sensing code from a plurality of sensing codes, each of the plurality of sensing codes comprising a respective ordered sequence of rates.

The apparatus may be further caused to receive an indication of one or more configuration parameters characterizing a construction of the sensing signal based on the ordered sequence of rates. The apparatus may be caused to transmit the sensing signal according to the sensing code by transmitting the sensing signal in accordance with the one or more configuration parameters and the sensing code.

The one or more configuration parameters may include one or more of: a start time of a first LFM in the ordered sequence of LFMs, a starting frequency of at least one LFM in the ordered sequence of LFMs, and a bandwidth of the sensing signal.

The sensing signal may include a repetition of the ordered sequence of LFMs in at least one of: time and frequency. The repetition may be in accordance with a repetition pattern. The one or more configuration parameters may include a characteristic of the repetition pattern.

The apparatus may be further caused to receive a signal comprising a reflection of the sensing signal from a first target, and determine, based on the received signal and a plurality of sensing codes including the sensing code, a sensing estimate for the first target.

In another aspect, another apparatus is provided. The apparatus includes a processor and a memory. The memory stores instructions which, when executed by the processor, cause the apparatus to receive a signal comprising a first sensing signal for a first target and determine, based on the received signal and a plurality of sensing codes, a first sensing estimate for the first target. The first sensing signal includes a first ordered sequence of LFMs. A first sensing code in the plurality of sensing codes includes a first ordered sequence of rates. Each of the LFMs in the first ordered sequence of LFMs has a slope specified by a corresponding rate in the first ordered sequence of rates.

Each of the plurality of sensing codes may corresponds to a respective transmitter apparatus.

The plurality of sensing codes may also include a second ordered sequence of rates. The received signal may also include a second sensing signal for a second target. The second sensing signal may include a second ordered sequence of LFMs, in which each of the LFMs in the second ordered sequence of LFMs has a slope specified by a corresponding rate in the second ordered sequence of rates. The apparatus may be further caused to determine, based on the second sensing signal and the plurality of sensing codes, a second sensing estimate for the second target.

The first and second sensing signal may have been transmitted by different transmitter apparatus. Alternatively, the first and second sensing signals were transmitted by the same transmitter apparatus, and the first target is different to the second target.

The first sensing signal may have been transmitted by the first target. The apparatus may be caused to determine the first sensing estimate by: identifying the first target based on a detection of the first sensing signal in the received signal; and determining the first sensing estimate based on the identity of the first target. The apparatus may be caused to identify the first target based on the detection of the first sensing signal in the received signal by: associating the first sensing code with the first sensing signal in the received signal, and identifying the first target apparatus based on the first sensing code.

The first sensing signal may have been received after having been transmitted by a particular transmitter apparatus and reflected by the first target. The apparatus may be further caused to determine the first sensing estimate by identifying the particular transmitter apparatus based on the detection of the first sensing signal in the received signal and determining the first sensing estimate based on the identity of the particular transmitter apparatus. The apparatus may be further caused to identify the particular transmitter apparatus based on the detection of the first sensing signal in the received signal by: associating the first sensing code with the first sensing signal in the received signal, and identifying the particular transmitter apparatus based on the first sensing code.

The apparatus may be further caused to receive the plurality of sensing codes.

### BRIEF DESCRIPTION OF THE DRAWINGS

For a more complete understanding of the present embodiments, and the advantages thereof, reference is now made, by way of example, to the following descriptions taken in conjunction with the accompanying drawings, in which:

FIG. 1 is a schematic diagram of a communication system in which embodiments of the disclosure may occur.

FIG. 2 is another schematic diagram of a communication system in which embodiments of the disclosure may occur.

FIG. 3 is a block diagram illustrating units or modules in a device in which embodiments of the disclosure may occur.

FIG. 4 is a block diagram illustrating units or modules in a device in which embodiments of the disclosure may occur.

FIG. 5 shows an example of a frequency modulated continuous waveform.

FIG. 6 shows an example of a triangular waveform.

FIG. 7 shows an example of an LFM-based waveform in accordance with embodiments of the disclosure.

FIG. 8 shows a system according to embodiments of the disclosure.

FIG. 9 shows a first sensing signal and a second sensing signal according to embodiments of the disclosure.

FIGS. 10-13 illustrate methods according to embodiments of the disclosure.

### DETAILED DESCRIPTION

The operation of the current example embodiments and the structure thereof are discussed in detail below. It should be appreciated, however, that the present disclosure provides many applicable inventive concepts that can be embodied in any of a wide variety of specific contexts. The specific embodiments discussed are merely illustrative of specific structures of the disclosure and ways to operate the disclosure, and do not limit the scope of the present disclosure.

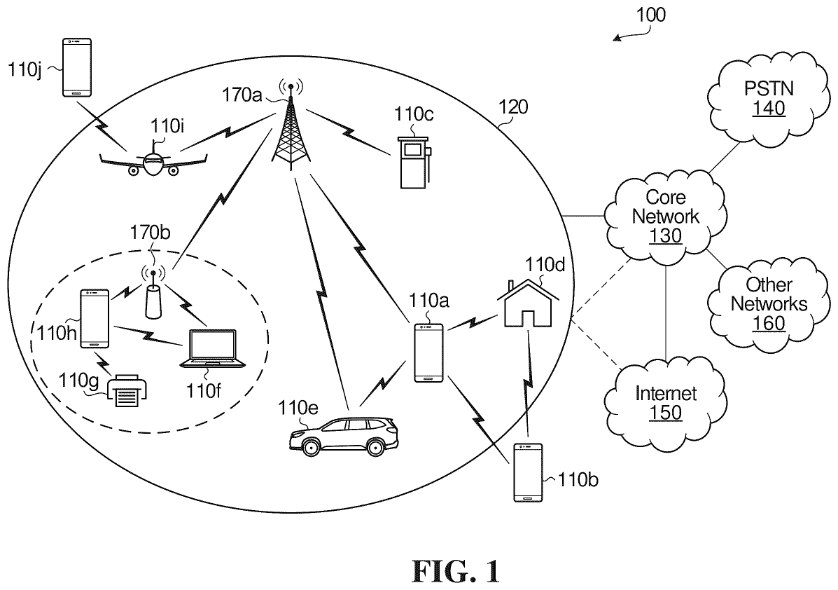

Referring to FIG. 1, as an illustrative example without limitation, a simplified schematic illustration of a communication system is provided. The communication system 100 comprises a radio access network 120. The radio access network 120 may be a next generation (e.g. sixth generation (6G) or later) radio access network, or a legacy (e.g. 5G, 4G, 3G or 2G) radio access network. One or more communication electronic device (ED) 110a-120j (generically referred to as 110) may be interconnected to one another or connected to one or more network nodes (170a, 170b, generically referred to as 170) in the radio access network 120. A core network 130 may be a part of the communication system and may be dependent or independent of the radio access technology used in the communication system 100. Also the communication system 100 comprises a public switched telephone network (PSTN) 140, the internet 150, and other networks 160.

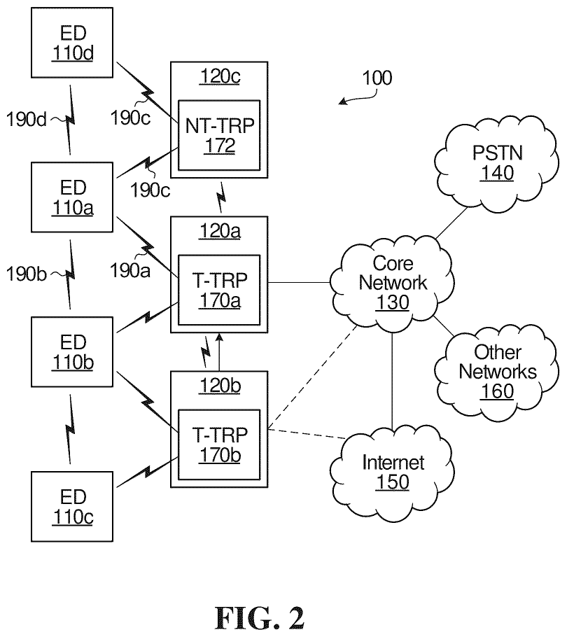

FIG. 2 illustrates an example communication system 100. In general, the communication system 100 enables multiple wireless or wired elements to communicate data and other content. The purpose of the communication system 100 may be to provide content, such as voice, data, video, and/or text, via broadcast, multicast and unicast, etc. The communication system 100 may operate by sharing resources, such as carrier spectrum bandwidth, between its constituent elements. The communication system 100 may include a terrestrial communication system and/or a non-terrestrial communication system. The communication system 100 may provide a wide range of communication services and applications (such as earth monitoring, remote sensing, passive sensing and positioning, navigation and tracking, autonomous delivery and mobility, etc.). The communication system 100 may provide a high degree of availability and robustness through a joint operation of the terrestrial communication system and the non-terrestrial communication system. For example, integrating a non-terrestrial communication system (or components thereof) into a terrestrial communication system can result in what may be considered a heterogeneous network comprising multiple layers. Compared to conventional communication networks, the heterogeneous network may achieve better overall performance through efficient multi-link joint operation, more flexible functionality sharing, and faster physical layer link switching between terrestrial networks and non-terrestrial networks.

The terrestrial communication system and the non-terrestrial communication system could be considered sub-systems of the communication system. In the example shown, the communication system 100 includes electronic devices (ED) 110a-110d (generically referred to as ED 110), radio access networks (RANs) 120a-120b, non-terrestrial communication network 120c, a core network 130, a public switched telephone network (PSTN) 140, the internet 150, and other networks 160. The RANs 120a-120b include respective base stations (BSs) 170a-170b, which may be generically referred to as terrestrial transmit and receive points (T-TRPs) 170a-170b. The non-terrestrial communication network 120c includes an access node 120c, which may be generically referred to as a non-terrestrial transmit and receive point (NT-TRP) 172.

Any ED 110 may be alternatively or additionally configured to interface, access, or communicate with any other T-TRP 170a-170b and NT-TRP 172, the internet 150, the core network 130, the PSTN 140, the other networks 160, or any combination of the preceding. In some examples, ED 110a may communicate an uplink and/or downlink transmission over an interface 190a with T-TRP 170a. In some examples, the EDs 110a, 110b and 110d may also communicate directly with one another via one or more sidelink air interfaces 190b. In some examples, ED 110d may communicate an uplink and/or downlink transmission over an interface 190c with NT-TRP 172.

The air interfaces 190a and 190b may use similar communication technology, such as any suitable radio access technology. For example, the communication system 100 may implement one or more channel access methods, such as code division multiple access (CDMA), time division multiple access (TDMA), frequency division multiple access (FDMA), orthogonal FDMA (OFDMA), or single-carrier FDMA (SC-FDMA) in the air interfaces 190a and 190b. The air interfaces 190a and 190b may utilize other higher dimension signal spaces, which may involve a combination of orthogonal and/or non-orthogonal dimensions.

The air interface 190c can enable communication between the ED 110d and one or multiple NT-TRPs 172 via a wireless link or simply a link. For some examples, the link is a dedicated connection for unicast transmission, a connection for broadcast transmission, or a connection between a group of EDs and one or multiple NT-TRPs for multicast transmission.

The RANs 120a and 120b are in communication with the core network 130 to provide the EDs 110a 110b, and 110c with various services such as voice, data, and other services. The RANs 120a and 120b and/or the core network 130 may be in direct or indirect communication with one or more other RANs (not shown), which may or may not be directly served by core network 130, and may or may not employ the same radio access technology as RAN 120a, RAN 120b or both. The core network 130 may also serve as a gateway access between (i) the RANs 120a and 120b or EDs 110a 110b, and 110c or both, and (ii) other networks (such as the PSTN 140, the internet 150, and the other networks 160). In addition, some or all of the EDs 110a 110b, and 110c may include functionality for communicating with different wireless networks over different wireless links using different wireless technologies and/or protocols. Instead of wireless communication (or in addition thereto), the EDs 110a 110b, and 110c may communicate via wired communication channels to a service provider or switch (not shown), and to the internet 150. PSTN 140 may include circuit switched telephone networks for providing plain old telephone service (POTS). Internet 150 may include a network of computers and subnets (intranets) or both, and incorporate protocols, such as Internet Protocol (IP), Transmission Control Protocol (TCP), User Datagram Protocol (UDP). EDs 110a 110b, and 110c may be multimode devices capable of operation according to multiple radio access technologies, and incorporate multiple transceivers necessary to support such.

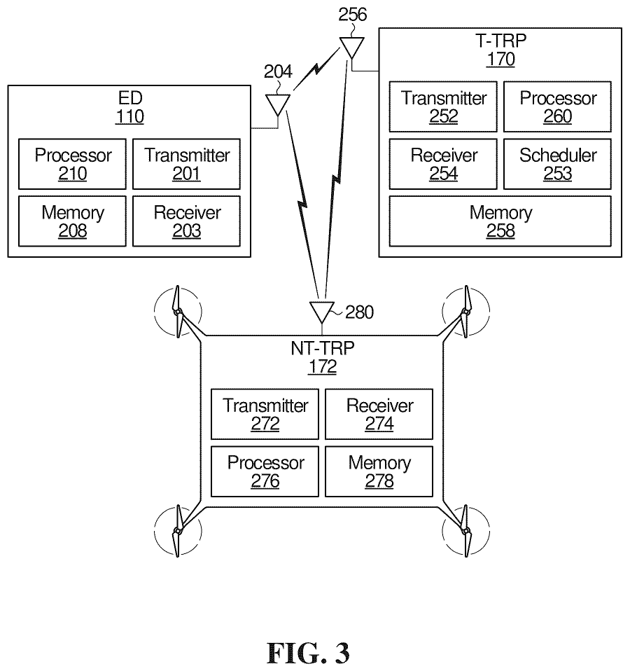

FIG. 3 illustrates another example of an ED 110 and a base station 170a, 170b and/or 170c. The ED 110 is used to connect persons, objects, machines, etc. The ED 110 may be widely used in various scenarios, for example, cellular communications, device-to-device (D2D), vehicle to everything (V2X), peer-to-peer (P2P), machine-to-machine (M2M), machine-type communications (MTC), internet of things (IOT), virtual reality (VR), augmented reality (AR), industrial control, self-driving, remote medical, smart grid, smart furniture, smart office, smart wearable, smart transportation, smart city, drones, robots, remote sensing, passive sensing, positioning, navigation and tracking, autonomous delivery and mobility, etc.

Each ED 110 represents any suitable end user device for wireless operation and may include such devices (or may be referred to) as a user equipment/device (UE), a wireless transmit/receive unit (WTRU), a mobile station, a fixed or mobile subscriber unit, a cellular telephone, a station (STA), a machine type communication (MTC) device, a personal digital assistant (PDA), a smartphone, a laptop, a computer, a tablet, a wireless sensor, a consumer electronics device, a smart book, a vehicle, a car, a truck, a bus, a train, or an IoT device, an industrial device, or apparatus (e.g. communication module, modem, or chip) in the forgoing devices, among other possibilities. Future generation EDs 110 may be referred to using other terms. The base station 170a and 170b is a T-TRP and will hereafter be referred to as T-TRP 170. Also shown in FIG. 3, a NT-TRP will hereafter be referred to as NT-TRP 172. Each ED 110 connected to T-TRP 170 and/or NT-TRP 172 can be dynamically or semi-statically turned-on (i.e. established, activated, or enabled), turned-off (i.e. released, deactivated, or disabled) and/or configured in response to one of more of: connection availability and connection necessity.

The ED 110 includes a transmitter 201 and a receiver 203 coupled to one or more antennas 204. Only one antenna 204 is illustrated. One, some, or all of the antennas may alternatively be panels. The transmitter 201 and the receiver 203 may be integrated, e.g. as a transceiver. The transceiver is configured to modulate data or other content for transmission by at least one antenna 204 or network interface controller (NIC). The transceiver is also configured to demodulate data or other content received by the at least one antenna 204. Each transceiver includes any suitable structure for generating signals for wireless or wired transmission and/or processing signals received wirelessly or by wire. Each antenna 204 includes any suitable structure for transmitting and/or receiving wireless or wired signals.

The ED 110 includes at least one memory 208. The memory 208 stores instructions and data used, generated, or collected by the ED 110. For example, the memory 208 could store software instructions or modules configured to implement some or all of the functionality and/or embodiments described herein and that are executed by the processing unit(s) 210. Each memory 208 includes any suitable volatile and/or non-volatile storage and retrieval device(s). Any suitable type of memory may be used, such as random access memory (RAM), read only memory (ROM), hard disk, optical disc, subscriber identity module (SIM) card, memory stick, secure digital (SD) memory card, on-processor cache, and the like.

The ED 110 may further include one or more input/output devices (not shown) or interfaces (such as a wired interface to the internet 150 in FIG. 1). The input/output devices permit interaction with a user or other devices in the network. Each input/output device includes any suitable structure for providing information to or receiving information from a user, such as a speaker, microphone, keypad, keyboard, display, or touch screen, including network interface communications.

The ED 110 further includes a processor 210 for performing operations including those related to preparing a transmission for uplink transmission to the NT-TRP 172 and/or T-TRP 170, those related to processing downlink transmissions received from the NT-TRP 172 and/or T-TRP 170, and those related to processing sidelink transmission to and from another ED 110. Processing operations related to preparing a transmission for uplink transmission may include operations such as encoding, modulating, transmit beamforming, and generating symbols for transmission. Processing operations related to processing downlink transmissions may include operations such as receive beamforming, demodulating and decoding received symbols. Depending upon the embodiment, a downlink transmission may be received by the receiver 203, possibly using receive beamforming, and the processor 210 may extract signaling from the downlink transmission (e.g. by detecting and/or decoding the signaling). An example of signaling may be a reference signal transmitted by NT-TRP 172 and/or T-TRP 170. In some embodiments, the processor 276 implements the transmit beamforming and/or receive beamforming based on the indication of beam direction, e.g. beam angle information (BAI), received from T-TRP 170. In some embodiments, the processor 210 may perform operations relating to network access (e.g. initial access) and/or downlink synchronization, such as operations relating to detecting a synchronization sequence, decoding and obtaining the system information, etc. In some embodiments, the processor 210 may perform channel estimation, e.g. using a reference signal received from the NT-TRP 172 and/or T-TRP 170.

Although not illustrated, the processor 210 may form part of the transmitter 201 and/or receiver 203. Although not illustrated, the memory 208 may form part of the processor 210.

The processor 210, and the processing components of the transmitter 201 and receiver 203 may each be implemented by the same or different one or more processors that are configured to execute instructions stored in a memory (e.g. in memory 208). Alternatively, some or all of the processor 210, and the processing components of the transmitter 201 and receiver 203 may be implemented using dedicated circuitry, such as a programmed field-programmable gate array (FPGA), a graphical processing unit (GPU), or an application-specific integrated circuit (ASIC).

The T-TRP 170 may be known by other names in some implementations, such as a base station, a base transceiver station (BTS), a radio base station, a network node, a network device, a device on the network side, a transmit/receive node, a Node B, an evolved NodeB (eNodeB or eNB), a Home eNodeB, a next Generation NodeB (gNB), a transmission point (TP)), a site controller, an access point (AP), or a wireless router, a relay station, a remote radio head, a terrestrial node, a terrestrial network device, or a terrestrial base station, base band unit (BBU), remote radio unit (RRU), active antenna unit (AAU), remote radio head (RRH), central unit (CU), distribute unit (DU), positioning node, among other possibilities. The T-TRP 170 may be macro BSs, pico BSs, relay node, donor node, or the like, or combinations thereof. The T-TRP 170 may refer to the forging devices or apparatus (e.g. communication module, modem, or chip) in the forgoing devices.

In some embodiments, the parts of the T-TRP 170 may be distributed. For example, some of the modules of the T-TRP 170 may be located remote from the equipment housing the antennas of the T-TRP 170, and may be coupled to the equipment housing the antennas over a communication link (not shown) sometimes known as front haul, such as common public radio interface (CPRI). Therefore, in some embodiments, the term T-TRP 170 may also refer to modules on the network side that perform processing operations, such as determining the location of the ED 110, resource allocation (scheduling), message generation, and encoding/decoding, and that are not necessarily part of the equipment housing the antennas of the T-TRP 170. The modules may also be coupled to other T-TRPs. In some embodiments, the T-TRP 170 may actually be a plurality of T-TRPs that are operating together to serve the ED 110, e.g. through coordinated multipoint transmissions.

The T-TRP 170 includes at least one transmitter 252 and at least one receiver 254 coupled to one or more antennas 256. Only one antenna 256 is illustrated. One, some, or all of the antennas may alternatively be panels. The transmitter 252 and the receiver 254 may be integrated as a transceiver. The T-TRP 170 further includes a processor 260 for performing operations including those related to: preparing a transmission for downlink transmission to the ED 110, processing an uplink transmission received from the ED 110, preparing a transmission for backhaul transmission to NT-TRP 172, and processing a transmission received over backhaul from the NT-TRP 172. Processing operations related to preparing a transmission for downlink or backhaul transmission may include operations such as encoding, modulating, precoding (e.g. MIMO precoding), transmit beamforming, and generating symbols for transmission. Processing operations related to processing received transmissions in the uplink or over backhaul may include operations such as receive beamforming, and demodulating and decoding received symbols. The processor 260 may also perform operations relating to network access (e.g. initial access) and/or downlink synchronization, such as generating the content of synchronization signal blocks (SSBs), generating the system information, etc. In some embodiments, the processor 260 also generates the indication of beam direction, e.g. BAI, which may be scheduled for transmission by scheduler 253. The processor 260 performs other network-side processing operations described herein, such as determining the location of the ED 110, determining where to deploy NT-TRP 172, etc. In some embodiments, the processor 260 may generate signaling, e.g. to configure one or more parameters of the ED 110 and/or one or more parameters of the NT-TRP 172. Any signaling generated by the processor 260 is sent by the transmitter 252. Note that “signaling”, as used herein, may alternatively be called control signaling. Dynamic signaling may be transmitted in a control channel, e.g. a physical downlink control channel (PDCCH), and static or semi-static higher layer signaling may be included in a packet transmitted in a data channel, e.g. in a physical downlink shared channel (PDSCH).

A scheduler 253 may be coupled to the processor 260. The scheduler 253 may be included within or operated separately from the T-TRP 170, which may schedule uplink, downlink, and/or backhaul transmissions, including issuing scheduling grants and/or configuring scheduling-free (“configured grant”) resources. The T-TRP 170 further includes a memory 258 for storing information and data. The memory 258 stores instructions and data used, generated, or collected by the T-TRP 170. For example, the memory 258 could store software instructions or modules configured to implement some or all of the functionality and/or embodiments described herein and that are executed by the processor 260.

Although not illustrated, the processor 260 may form part of the transmitter 252 and/or receiver 254. Also, although not illustrated, the processor 260 may implement the scheduler 253. Although not illustrated, the memory 258 may form part of the processor 260.

The processor 260, the scheduler 253, and the processing components of the transmitter 252 and receiver 254 may each be implemented by the same or different one or more processors that are configured to execute instructions stored in a memory, e.g. in memory 258. Alternatively, some or all of the processor 260, the scheduler 253, and the processing components of the transmitter 252 and receiver 254 may be implemented using dedicated circuitry, such as a FPGA, a GPU, or an ASIC.

Although the NT-TRP 172 is illustrated as a drone only as an example, the NT-TRP 172 may be implemented in any suitable non-terrestrial form. Also, the NT-TRP 172 may be known by other names in some implementations, such as a non-terrestrial node, a non-terrestrial network device, or a non-terrestrial base station. The NT-TRP 172 includes a transmitter 272 and a receiver 274 coupled to one or more antennas 280. Only one antenna 280 is illustrated. One, some, or all of the antennas may alternatively be panels. The transmitter 272 and the receiver 274 may be integrated as a transceiver. The NT-TRP 172 further includes a processor 276 for performing operations including those related to: preparing a transmission for downlink transmission to the ED 110, processing an uplink transmission received from the ED 110, preparing a transmission for backhaul transmission to T-TRP 170, and processing a transmission received over backhaul from the T-TRP 170. Processing operations related to preparing a transmission for downlink or backhaul transmission may include operations such as encoding, modulating, precoding (e.g. MIMO precoding), transmit beamforming, and generating symbols for transmission. Processing operations related to processing received transmissions in the uplink or over backhaul may include operations such as receive beamforming, and demodulating and decoding received symbols. In some embodiments, the processor 276 implements the transmit beamforming and/or receive beamforming based on beam direction information (e.g. BAI) received from T-TRP 170. In some embodiments, the processor 276 may generate signaling, e.g. to configure one or more parameters of the ED 110. In some embodiments, the NT-TRP 172 implements physical layer processing, but does not implement higher layer functions such as functions at the medium access control (MAC) or radio link control (RLC) layer. As this is only an example, more generally, the NT-TRP 172 may implement higher layer functions in addition to physical layer processing.

The NT-TRP 172 further includes a memory 278 for storing information and data. Although not illustrated, the processor 276 may form part of the transmitter 272 and/or receiver 274. Although not illustrated, the memory 278 may form part of the processor 276.

The processor 276 and the processing components of the transmitter 272 and receiver 274 may each be implemented by the same or different one or more processors that are configured to execute instructions stored in a memory, e.g. in memory 278. Alternatively, some or all of the processor 276 and the processing components of the transmitter 272 and receiver 274 may be implemented using dedicated circuitry, such as a programmed FPGA, a GPU, or an ASIC. In some embodiments, the NT-TRP 172 may actually be a plurality of NT-TRPs that are operating together to serve the ED 110, e.g. through coordinated multipoint transmissions.

The T-TRP 170, the NT-TRP 172, and/or the ED 110 may include other components, but these have been omitted for the sake of clarity.

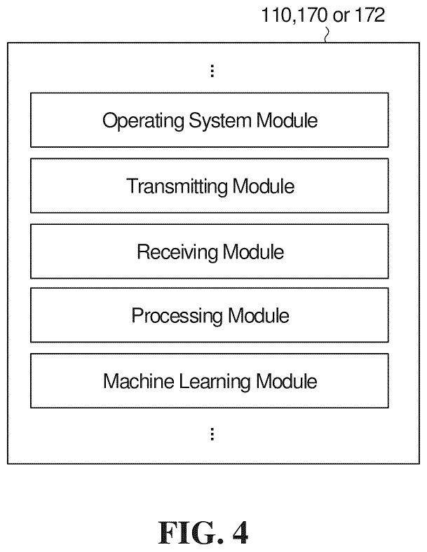

One or more steps of the embodiment methods provided herein may be performed by corresponding units or modules, according to FIG. 4. FIG. 4 illustrates units or modules in a device, such as in ED 110, in T-TRP 170, or in NT-TRP 172. For example, a signal may be transmitted by a transmitting unit or a transmitting module. For example, a signal may be transmitted by a transmitting unit or a transmitting module. A signal may be received by a receiving unit or a receiving module. A signal may be processed by a processing unit or a processing module. Other steps may be performed by an artificial intelligence (AI) or machine learning (ML) module. The respective units or modules may be implemented using hardware, one or more components or devices that execute software, or a combination thereof. For instance, one or more of the units or modules may be an integrated circuit, such as a programmed FPGA, a GPU, or an ASIC. It will be appreciated that where the modules are implemented using software for execution by a processor for example, they may be retrieved by a processor, in whole or part as needed, individually or together for processing, in single or multiple instances, and that the modules themselves may include instructions for further deployment and instantiation.

Additional details regarding the EDs 110, T-TRP 170, and NT-TRP 172 are known to those of skill in the art. As such, these details are omitted here.

A sensing system may be used to help gather pose information for a particular object, such as an apparatus. Pose information may include, for example, one or more of: a relative location of the particular object (e.g. with respect to a reference point or other apparatus), location in a global coordinate system, movement of the object (relative or in a global coordinate system), orientation information and the information about the wireless environment. “Location” is also known as “position” and these two terms may be used interchangeably herein. The relative location of the object may include a distance to the object and/or a direction to the object. The movement of the object may include a speed, direction of movement and/or acceleration of the object, for example.

Sensing systems may be particularly useful for obtaining pose information for electronic devices, which may be referred to as ED pose information. ED pose information may be used in cellular communication networks to improve various performance metrics for the network. Such performance metrics may, for example, include capacity, agility and/or efficiency. The improvement may be achieved when elements of the network exploit the position, the behavior, the mobility pattern, etc. of the ED in the context of a priori information describing a wireless environment in which the ED is operating.

Examples of well-known sensing systems include RADAR (Radio Detection and Ranging) and LIDAR (Light Detection and Ranging). While the sensing system is typically separate from the communication system, it could be advantageous to gather the information using an integrated system to reduce the hardware (and cost) in the system as well as the time, frequency or spatial resources needed to perform both functionalities. However, using the communication system hardware to perform sensing of ED pose and environment information is a highly challenging problem. The difficulty of the problem relates to factors such as the limited resolution of the communication system, the dynamicity of the environment, and the huge number of objects whose electromagnetic properties and position are to be estimated.

Accordingly, integrated sensing and communication (also known as integrated communication and sensing) is a desirable feature in existing and future communication systems.

Any or all of the EDs 110 and TRPs 170 may be sensing nodes in the system 100. Sensing nodes are network entities that perform sensing by transmitting and receiving sensing signals. Some sensing nodes are communication equipment that perform both communications and sensing. However, it is possible that some sensing nodes do not perform communications and are, instead, dedicated to sensing. For example, the system 100 may further include a dedicated sensing agent, which is an example of a sensing node that is dedicated to sensing. Unlike the EDs 110 and TRPs 170, the dedicated sensing agent does not transmit or receive communication signals. However, the dedicated sensing agent may communicate configuration information, sensing information, signaling information, or other information within the communication system 100. In some cases, a plurality of dedicated sensing agents may be implemented and may communicate with each other to jointly perform a sensing task. The dedicated sensing agent may be in communication with the core network 130 to communicate information with the rest of the communication system 100. By way of example, the dedicated sensing agent may determine the location of the ED 110a, and transmit this information to the base station 170a via the core network 130. Although no dedicated sensing agent is shown in FIG. 2, any number of sensing agents may be implemented in the communication system 100. In some embodiments, one or more dedicated sensing agents may be implemented at one or more of the RANS 120.

A sensing node may combine sensing-based techniques with reference signal-based techniques to enhance UE pose determination. Reference signal-based techniques may be considered as a type of bi-static (or multi-static) sensing, particularly when measurements of reference signals are used for pose estimation. This type of sensing node may also be known as a node that implements a sensing management function (SMF). In some networks, the SMF may also be known as a node that implements a location management function (LMF). The SMF may be implemented as a physically independent entity located at the core network 130 with connection to the multiple TRPs 170. In other aspects of the present application, the SMF may be implemented as a logical entity co-located inside a TRP, such as the T-TRP 170, through logic carried out by a processor in the TRP, such as the processor 260.

In one example, an SMF may be implemented as a physically independent entity that includes at least one processor, at least one transmitter, at least one receiver, one or more antennas and at least one memory. A transceiver may be used instead of the transmitter and the receiver. A scheduler may be coupled to the processor of the SMF. The scheduler may be included within or operated separately from the SMF. The processor implements various processing operations of the SMF, such as signal coding, data processing, power control, input/output processing or any other functionality. The processor can also be configured to implement some or all of the functionality and/or embodiments described in more detail above. The processor includes any suitable processing or computing device configured to perform one or more operations. The processor could, for example, include a microprocessor, microcontroller, digital signal processor, field programmable gate array or application specific integrated circuit.

A reference signal-based pose determination technique belongs to an “active” pose estimation paradigm. In an active pose estimation paradigm, the enquirer of pose information (e.g. the electronic device 110) takes part in process of determining the pose of the enquirer. The enquirer may transmit or receive and process (or both transmit and receive/process) a signal that is specific to the pose determination process. Positioning techniques based on a global navigation satellite system (GNSS) such as the known Global Positioning System (GPS) are other examples of the active pose estimation paradigm. Various positioning technologies are also known in NR systems and in LTE systems.

In contrast, a sensing technique, based on radar and/or lidar for example, may be considered as belonging to a “passive” pose determination paradigm. In a passive pose determination paradigm, the target may be oblivious to the pose determination process.

By integrating sensing and communications in one system, the system need not operate according to only a single paradigm. Thus, the combination of sensing-based techniques and reference signal-based techniques can yield enhanced pose determination.

The enhanced pose determination may, for example, include obtaining ED channel sub-space information, which is particularly useful for ED channel reconstruction at the sensing node, especially for a beam-based operation and communication. The ED channel sub-space is a subset of the entire algebraic space, defined over the spatial domain, in which the entire channel from the TP to the ED lies. Accordingly, the ED channel sub-space defines the TRP-to-ED channel with very high accuracy. The signals transmitted over other sub-spaces result in a negligible contribution to the ED channel. Knowledge of the ED channel sub-space helps to reduce the effort needed for channel measurement at the ED and channel reconstruction at the network-side. Therefore, the combination of sensing-based techniques and reference signal-based techniques may enable the ED channel reconstruction with much less overhead as compared to traditional methods. Sub-space information can also facilitate sub-space-based sensing to reduce sensing complexity and improve sensing accuracy.

In some embodiments of integrated sensing and communication, a same radio access technology (RAT) is used for sensing and communication. This avoids the need to multiplex two different RATs under one carrier spectrum, or necessitating two different carrier spectrums for the two different RATs.

In embodiments that integrate sensing and communication under one RAT, a first set of channels may be used to transmit a sensing signal and a second set of channels may be used to transmit a communications signal. In some embodiments, each channel in the first set of channels and each channel in the second set of channels is a logical channel, a transport channel or a physical channel.

At the physical layer, communication and sensing may be performed via separate physical channels. For example, a first physical downlink shared channel PDSCH-C is defined for data communication, while a second physical downlink shared channel PDSCH-S is defined for sensing. Similarly, separate physical uplink shared channels (PUSCH), PUSCH-C and PUSCH-S, could be defined for uplink communication and sensing.

In another example, the same channels (e.g. the same PDSCH and PUSCH) could be used for both communication and sensing. Separate logical layer channels and/or transport layer channels may be defined for communication and sensing. Note also that control channel(s) and data channel(s) for sensing can have the same or different channel structure (format), occupy same or different frequency bands or bandwidth parts.

In a further example, a common physical downlink control channel (PDCCH) and a common physical uplink control channel (PUCCH) may be used to carry control information for both sensing and communication. Alternatively, separate physical layer control channels may be used to carry separate control information for communication and sensing. For example, PUCCH-S and PUCCH-C could be used for uplink control for sensing and communication respectively and PDCCH-S and PDCCH-C for downlink control for sensing and communication respectively.

Different combinations of shared and dedicated channels for sensing and communication, at each of the physical, transport, and logical layers, are possible.

The term RADAR originates from the phrase Radio Detection and Ranging; however, expressions with different forms of capitalization (e.g. Radar and radar) are equally valid and now more common. Radar is typically used for detecting a presence and a location of an object. A radar system radiates radio frequency energy and receives echoes of the energy reflected from one or more targets. The system determines the pose of a given target based on the echoes (also referred to as reflections) returned from the given target. The radiated energy can be in the form of an energy pulse or a continuous wave, which can be expressed or defined by a particular waveform. Examples of waveforms used in radar include frequency modulated continuous wave (FMCW) and ultra-wideband (UWB) waveforms.

Radar systems can be monostatic, bi-static or multi-static. In a monostatic radar system, the radar signal transmitter and receiver are co-located, such as being integrated in a transceiver. In a bi-static radar system, the transmitter and receiver are spatially separated. The distance of separation is typically comparable to, or larger than, the expected target distance (often referred to as the range). In a multi-static radar system, two or more radar components are spatially diverse but with a shared area of coverage. A multi-static radar is also referred to as a multisite or netted radar.

Terrestrial radar applications encounter challenges such as multipath propagation and shadowing impairments. Another challenge is the problem of identifiability because terrestrial targets have similar physical attributes. Integrating sensing into a communication system is likely to suffer from these same challenges, and more.

Communication nodes can be either half-duplex or full-duplex. A half-duplex node cannot both transmit and receive using the same physical resources (time, frequency, etc.); conversely, a full-duplex node can transmit and receive using the same physical resources. Existing commercial wireless communications networks are all half-duplex. Even if full-duplex communications networks become practical in the future, it is expected that at least some of the nodes in the network will still be half-duplex nodes because half-duplex devices are less complex, and have lower cost and lower power consumption. In particular, full-duplex implementation is more challenging at higher frequencies (e.g. in millimeter wave bands) and very challenging for small and low-cost devices, such as femtocell base stations and UEs.

The limitation of half-duplex nodes in the communications network presents further challenges toward integrating sensing and communications into the devices and systems of the communications network. For example, both half-duplex and full-duplex nodes can perform bi-static or multi-static sensing, but monostatic sensing typically requires the sensing node have full-duplex capability. A half-duplex node may perform monostatic sensing with certain limitations, such as in a pulsed radar with a specific duty cycle and ranging capability.

Properties of a sensing signal, or a signal used for both sensing and communication, include the waveform of the signal and the frame structure of the signal. The frame structure defines the time-domain boundaries of the signal. The waveform describes the shape of the signal as a function of time and frequency.

It is envisioned that the majority of nodes in future wireless networks will be capable of performing sensing. However, wireless networks have limited network resources. Techniques for effectively and efficiently sharing the wireless channel between multiple nodes are needed to prevent sensing performance from being limited by the availability of wireless resources.

Techniques for sharing a wireless channel between multiple sensing nodes may be referred to as sensing multiple access. Sensing multiple access seeks to enable sensing services for multiple sensing nodes using the limited time-frequency resources in a shared medium (i.e., the wireless channel). An effective sensing multiple access technique should seek to minimise interference between different sensing nodes. Interference may occur when, for example, sensing nodes that are close to one another transmit on the same time-frequency resources.

One approach to sharing a wireless channel between multiple sensing nodes is to schedule different sensing nodes in separate time-frequency resources to reduce the risk of interference when the nodes perform sensing. However, this may result in significant demand for time-frequency resources to enable sensing across a network, which may be detrimental to the performance of other services, such as communication services.

Another approach is to provide sensing nodes with orthogonal or semi-orthogonal sensing waveforms to reduce the demand for time-frequency resources. A receiver of this sensing signal can use post-processing (e.g. by using a correlator) to differentiate between different sensing signals.

A combination of these two approaches may be adopted. For example, the 5^{th} Generation (5G) New Radio (NR) standard defines OFDM-modulated Zadoff-Chu sequences for Uplink Sounding Reference Signals (UL-SRS). UL-SRS may be used in communication networks for tasks such as channel sounding, uplink transmission of timing control, and reciprocity-based multi-user downlink precoding. For multiple access in 5G NR networks, different apparatus (e.g. different user equipments) may be assigned different time-frequency resources and/or different parameters of a Zadoff-Chu sequence.

As another example, downlink positioning reference signals (DL-PRS) in 5G NR networks may be based on a Gold sequence, such that different apparatus (e.g. different TRPs) can be multiplexed in the time-frequency domain as well as according to the parameters of the Gold sequence.

In 5G NR networks, the waveforms of UL-SRS and DL-PRS are defined in the digital baseband domain in the form of sequences. Although such digitally defined signals provide flexibility in multiple access, processing sequences at the receiver side can be complex and power consuming due to the need for digital baseband processing to achieve acceptable performance.

While 5G NR standard defines digital sequences for communication, Radar, which is an example of sensing, has typically used linear frequency modulated signal-based waveforms, which are expressed in the radio frequency (RF) analog domain. A linear frequency modulated signal (LFM) has a frequency that is a linear function of time. An LFM may also be referred to as a chirp. The slope of an LFM may be referred to as the rate, or chirp rate, of the LFM.

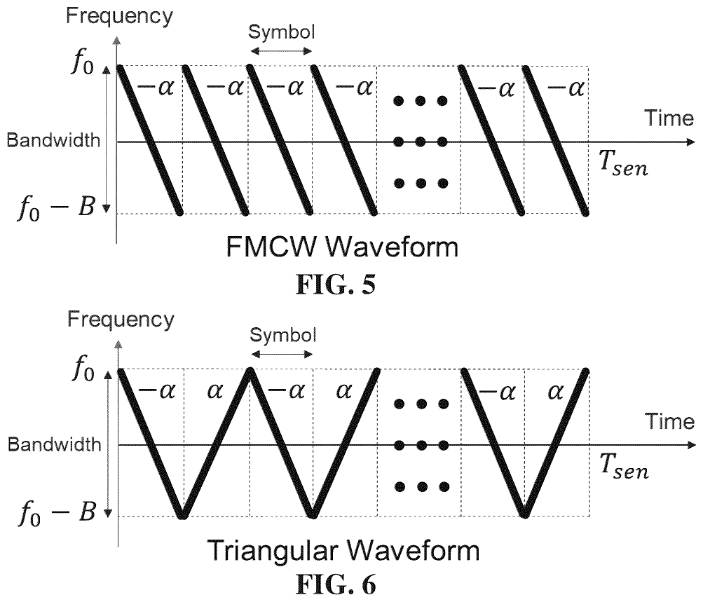

Two examples of LFM-based waveforms that have been used for Radar are shown in FIGS. 5 and 6. Both of these waveforms are a combination of LFMs.

FIG. 5 shows an example of a frequency modulated continuous waveform (FMCW) of duration Tₛₑₙ. The FMCW signal comprises a plurality of LFMs. Each LFM has the same starting frequency ƒ₀, ending frequency ƒ₀−B (and thus the same bandwidth B) and rate −α. The FMCW thus effectively comprises a sequence of identical LFMs. This may also be described as several parallel LFMs being multiplexed in time, in which each of the LFMs has the same rate. In this example, each LFM spans a symbol. In general, the LFMs may have any suitable duration. The duration of each LFM in an FMCW signal will be the same since they have the same rate and bandwidth.

FIG. 6 shows an example of a triangular waveform. The triangle waveform comprises a sequence of LFMs having the same absolute rate, but with alternating signs. In the illustrated example, the first LFM has a rate of −α and the second LFM has a rate of α. This sequence repeats until the end of the waveform. This creates symmetric triangles in the time-frequency domain.

Both the FMCW waveform and the triangular waveform are expressed in the radio frequency analog domain and can be processed by low complexity receivers. As a result of their temporal correlation properties, they can also be used to achieve a high sensing performance. However, the FMCW waveform can cause significant out-of-band emissions due to the phase discontinuities between subsequent LFMs. In addition, both the triangle waveform and the FMCW waveform have limited flexibility for multiple access because they only provide limited degrees of freedom. The FMCW waveform, for example, comprises parallel LFM that have the same rates. This restricts the degrees of freedom available for multiple access. The triangular waveform has a similar drawback. The rate of the LFMs in the triangular waveform is either α or −α which does not provide a suitable number of degrees of freedom for multiple access. Having only limited degrees of freedom for multiple access may necessitate separating multiple sensing transmitters in time and/or frequency domains to avoid severe interference. Interference can reduce sensing performance and may make it difficult for a receiver to distinguish between sensing signals transmitted by different transmitters. Separating transmitters in the time and/or frequency domains may reduce efficiency as it may result in the demand for network resources for sensing increasing with the number of sensing transmitters.

According to aspects of the present disclosure, a generalized LFM-based waveform may be used for sensing to increase the degrees of freedom of the sensing scheme. As a result, the generalized LFM-based waveform may enable practical sensing multiple access techniques. This generalized LFM-based waveform may, for example, provide high flexibility in multiplexing sensing transmitters while still allowing the sensing signals to be processed by low complexity and low power-consumption receivers.

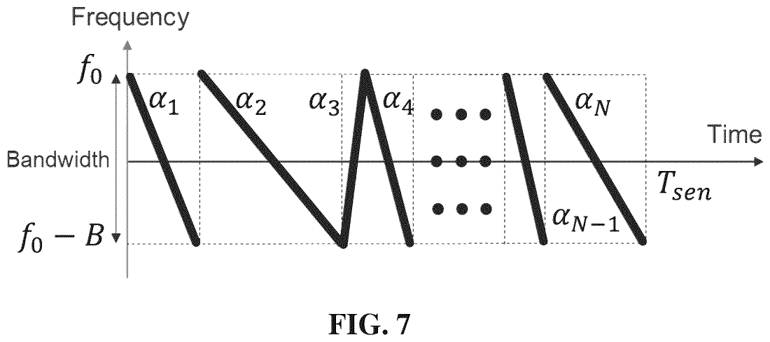

An example of such a generalized LFM-based waveform is shown in FIG. 7. The generalized LFM-based waveform comprises an ordered sequence of LFMs i=1, 2, . . . N, in which each LFM i has a respective rate aᵢ. Each LFM in the ordered sequence occurs after (e.g. immediately after) another LFM in time. The LFMs are effectively multiplexed in the time domain to form the waveform. Each LFM has the same maximum frequency ƒ₀ and minimum frequency ƒ₀−B, and thus the same bandwidth B. Each LFM has a respective rate at such that the waveform may be identified by the rates of the LFMs forming the waveform. The rates of the LFMs forming the waveform may be expressed as a sequence of rates (α₁, α₂, α₃, α₄, . . . α_{N-1}, α_{N}).

It will be appreciated that the waveform shown in FIG. 7 is merely an example of a generalized LFM-based waveform according to embodiments of the disclosure. In general, a generalized LFM-based waveform as described herein may comprise any ordered sequence of LFMs with respective rates. As such, the FMCW waveform may be understood to be a special case of the generalized LFM-based waveform in which all of the rates are the same (e.g. αᵢ=α). The triangular waveform is another special case in which each of the rates of the LFMs in the sequence alternate between α and −α (e.g. αᵢ=α for even i and αᵢ=−α, otherwise). Another special case of the generalized LFM-based waveform may be a waveform in which at least two of the LFMs in the generalized LFM-based waveform may have different absolute rates.

A particular instance of a generalized LFM-based waveform may be specified by some or all of the following parameters: a number of LFMs included in the waveform, Nᵢ; a start time of the first LFM in the waveform, tᵢ; a start frequency of the first LFM in the waveform, ƒᵢ; a bandwidth of the waveform, Bᵢ; an ordered sequence of the rates of the LFMs in the waveform,

$$( {α}_{1}^{i} , {α}_{2}^{i} , … , {α}_{{N}_{i}}^{i} ) ;$$

and, if the waveform includes a repetition of the ordered sequence of rates (in time and/or frequency), a pattern of the repetition e.g. as defined by periodicity of transmission in time \tilde{T}ᵢ and/or frequency \tilde{F}ᵢ. It will be appreciated that some of these parameters are interdependent, which means that a particular waveform may be defined using only some of these parameters. It will also be appreciated that other parameters may be used to define the same properties in a different way. For example, the duration of the waveform and the sequence of rates may be used to define the bandwidth of the waveform (since time and frequency are linearly dependent for each LFM and the slope of the linear relationship for each LFM is the rate defined by the sequence of rates). As described in more detail below, in some examples, a particular instance of a generalized LFM-based waveform may be associated with a particular entity (e.g. a particular transmitter apparatus, a particular target etc.). In those examples, the index i may be associated with an identity or identifier of that entity. In some examples, the index i may be associated with an identity or identifier of a sensing session.

As the generalized LFM-based waveform is based on an LFM, it may be processed by a low complexity and low power receiver. In addition, a lack of symmetry in a particular LFM-based waveform does not seem to impact out-of-band emissions (e.g. does not seem to cause any increase in out-of-band emission), which means that the generalized LFM-based waveform need not be constrained to the symmetry of the triangle waveform. In addition, since the generalized LFM-based waveform may include LFMs with different absolute rates, different sequences of rates may be used to construct a large number of different waveforms.

According to aspects of the disclosure, different transmitter apparatus may use a different waveform for sensing, in which each waveform is based on the generalized LFM-based waveform described above. That is, each transmitter apparatus may be assigned a waveform formed from an ordered sequence of LFMs with respective rates. This allows for differentiating between sensing signals transmitted by different transmitter apparatus based on the waveform of the sensing signal, which means that different transmitter apparatus may use the same or overlapping network resources (e.g. time-frequency resources) for sensing. As the number of distinct waveforms that can be constructed from the generalized LFM-based waveform is large, this provides a large number of degrees of freedom for facilitating sensing multiple access.

Since the waveform assigned to particular transmitter apparatus is formed from an ordered sequence of LFMs with respective rates, the waveform may be identified by its particular sequence of rates. According to aspects of the present disclosure, a particular waveform (e.g. for a particular transmitter apparatus) may be identified by a code, or sensing code, which includes an ordered sequence of rates. Thus, for example, the generalized LFM-based waveform shown in FIG. 7 may be identified by the sensing code (α₁, α₂, α₃, α₄, . . . α_{N-1}, α_{N}). This allows for concisely identifying a waveform for a particular transmitter apparatus.

Aspects of the present disclosure thus enable highly flexible multiple access for sensing whilst minimizing the power consumption and complexity of receiver apparatus.

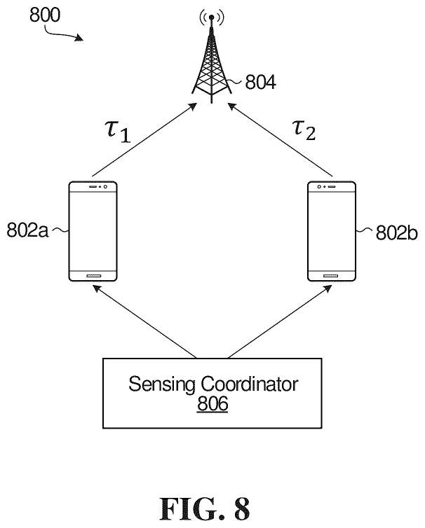

FIG. 8 shows a system 800 according to embodiments of the disclosure.

The system 800 comprises a first transmitter apparatus 802a, a second transmitter apparatus 802b, a receiver apparatus 804 and a sensing coordinator 806.

The first and second transmitter apparatus 802a, 802b may be collectively referred to as the transmitter apparatus 802. In general, the system 800 may comprise two or more transmitter apparatus 802.

Each of the transmitter apparatus 802 includes a processor, a transmitter, an antenna and a memory. One or more of the transmitter apparatus 802 may further comprise a receiver. Alternatively, one or more of the transmitter apparatus 802 may comprise a transceiver instead of the transmitter and the receiver. The processor implements various operations of the respective transmitter apparatus 802, including the operations described below as well as other operations such as such as signal coding, data processing, power control or any other functionality. The processor includes any suitable processing or computing device configured to perform the one or more operations. The processor could, for example, include a microprocessor, microcontroller, digital signal processor, field programmable gate array or application specific integrated circuit.

In the illustrated embodiment, each of the transmitter apparatus 802 comprises an electronic device. Thus, each of the transmitter apparatus 802 may be any of the electronic devices 110 described above in respect of FIGS. 1-4. In other embodiments, one or more of the transmitter apparatus 802 might not be an electronic device. For example, one or more of the transmitter apparatus 802 may comprise a TRP (e.g. may be a network node or base station), such as any of the TRPs 170 described above in respect of FIGS. 1-4). In general, each of the transmitter apparatus 802 may be any apparatus (e.g. device or node) capable of transmitting a sensing signal. The transmitter apparatus 802 may comprise a sensing node or agent (e.g. the sensing agent described above). In particular examples, one or more of the transmitter apparatus 802 may additionally be capable of transmitting and/or receiving a communication signal. One or more of the transmitter apparatus 802 may, for example, comprise an ISAC device.

The receiver apparatus 804 includes a processor, a receiver, an antenna and a memory. The receiver apparatus 804 may further comprise a transmitter. Alternatively, the receiver apparatus 804 may comprise a transceiver instead of the transmitter and the receiver. The processor implements various operations of the receiver apparatus 804, including the operations described below as well as other operations such as such as signal coding, data processing, power control or any other functionality. The processor includes any suitable processing or computing device configured to perform the one or more operations. The processor could, for example, include a microprocessor, microcontroller, digital signal processor, field programmable gate array or application specific integrated circuit.

In the illustrated embodiment, the receiver apparatus 804 is a TRP. The receiver apparatus 804 may comprise any suitable TRP (e.g. may be a network node or base station), such as any of the TRPs 170 described above in respect of FIGS. 1-4). In particular examples, the receiver apparatus 804 may comprise a base station serving a cell to which the transmitter apparatus 802 are connected. In other embodiments, the receiver apparatus 804 might not be a TRP. For example, the receiver apparatus 804 may be an electronic device, such as any of the electronic devices 110 described above in respect of FIGS. 1-4. In general, the receiver apparatus 804 may be any apparatus (e.g. device or node) capable of receiving a sensing signal or reflection of a sensing signal. The receiver apparatus 804 may comprise a sensing node or sensing agent (e.g. the sensing agent described above), for example. In particular examples, the receiver apparatus 804 may additionally be capable of transmitting and/or receiving a communication signal. The receiver apparatus 804 may, for example, comprise an ISAC device.

The sensing coordinator 806 includes a processor, a transmitter, an antenna and a memory. The sensing coordinator 806 may further comprise a receiver. Alternatively, the sensing coordinator 806 may comprise a transceiver instead of the transmitter and the receiver. The processor implements various operations of the sensing coordinator 806, including the operations described below as well as other suitable operations. The processor includes any suitable processing or computing device configured to perform the operations described below. The processor could, for example, include a microprocessor, microcontroller, digital signal processor, field programmable gate array or application specific integrated circuit.

The sensing coordinator 806 may comprise a TRP (e.g. may be a network node or base station), such as any of the TRPs 170 described above in respect of FIGS. 1-4. The sensing coordinator 806 may comprise an electronic device, such as any of the electronic devices 110 described above in respect of FIGS. 1-4. In some embodiments, the sensing coordinator 806 may comprise a node in a core network (e.g. of a communications network comprising the system 800). That is, the sensing coordinator 806 may be a core network node. For example, the sensing coordinator 806 may be a core network node and the transmitter apparatus 802 may be base stations connected to the sensing coordinator 806 (e.g. via a backhaul network). In some embodiments, the sensing coordinator 806 may comprise a sensing management function, such as the SMF described above. In general, the sensing coordinator 806 may comprise any apparatus (e.g. node or device) capable of performing the operations of the sensing coordinator 806 discussed below.

In some embodiments, the sensing coordinator 806 and the receiver apparatus 804 may be the same. That is, one apparatus may implement the operations of the sensing coordinator 806 and the receiver apparatus 804 as described herein. In other embodiments, such as the embodiment illustrated in FIG. 8, the sensing coordinator 806 and the receiver apparatus 804 may be implemented in different apparatus.

### Sensing Codes

According to aspects of the present disclosure, the first transmitter apparatus 802a and the second transmitter apparatus 802b may be assigned respective sensing codes defining, for each of the first and second transmitter apparatus 802a, 802b, a respective sensing signal formed from an ordered sequence of LFMs. The LFMs may alternatively be referred to as chirps.

Each of the sensing codes includes (e.g. may consist of) a respective ordered sequence of rates. The rates may be referred to as chirp rates, slopes or gradients. Each rate indicates the slope or gradient of a respective LFM such that a particular ordered sequence of rates specifies (e.g. defines) a sensing signal formed from a sequence of LFMs having the specified rates. That is, each sensing code may have a one-to-one correspondence with a generalized LFM-based sensing waveform in which the rates of the successive LFMs in the waveform are specified by the sensing code. For example, the signal illustrated in FIG. 7 described above may correspond to the sensing code (α₁, α₂, α₃, α₄, . . . , α_{N}).

The sensing codes for the first and second transmitter apparatus 802a, 802b may be selected from a plurality of sensing codes. The sensing codes may alternatively be referred to as sensing codewords or sensing signal indicators. Each of the sensing codes in the plurality of sensing codes may be distinct. As such, each of the sensing codes may define a distinct (e.g. different) sensing signal. The plurality of sensing codes may be referred to as a set of sensing codes, a codebook, a dictionary, a sensing codebook or a sensing dictionary, for example.

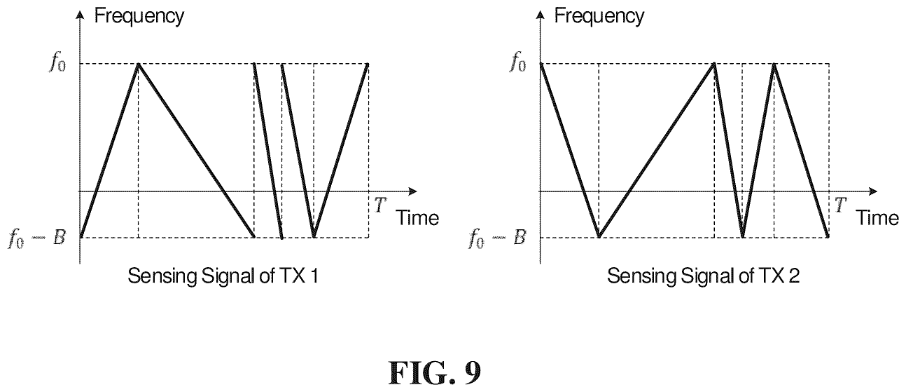

The plurality of sensing codes, including the sensing codes for the first and second transmitter apparatus 802a, 802b, may be formed using a set of rates Φ. This may be illustrated by reference to FIG. 9 which shows a first sensing signal (labelled “Sensing Signal of TX1”) for the first transmitter apparatus 802a defined by a first sensing code and a second sensing signal (labelled “Sensing Signal of TX2”) for the second transmitter apparatus 802b defined by a second sensing code. In this example, the first and second sensing codes are created using the set of rates Φ={α₁, −α₁, α₂, −α₂, α₃, −α₃} and each of the sensing signals is formed from five LFMs. The first sensing code is (α₁, −α₂, −α₃, −α₃, α₁), such that the first LFM in the first sensing signal has a slope of α₁, the second LFM has a slope of −α₂, the third LFM has a slope of −α₃, etc. The second sensing code is (−α₁, α₂, −α₃, α₃, −α₁), such that such that the first LFM in the second sensing signal has a slope of −α₁, the second LFM has a slope of α₂, the third LFM has a slope of −α₃, etc.

In general, a plurality of sensing codes (e.g. including the sensing codes for the first and second transmitter apparatus 802a, 802b) may be based on a set of rates Φ. The set Φ may effectively define an alphabet of the sensing codes. That is, each of the rates used in each sensing code may belong to the set Φ. The number of possible sensing codes may depend on the size of the set of rates Φ. Thus, the number of possible sensing codes may be increased by increasing the size of the set of rates Φ. As each transmitter apparatus should be assigned a unique sensing code, the number of sensing codes may limit the number of transmitter apparatus that may be supported. Therefore, having a large Φ and thus a large number of possible sensing codes may be particularly advantageous because it may enable supporting more transmitter apparatus. Having a large number of sensing codes may also enable assigning sensing codes to particular transmitter apparatus in order to reduce interference between transmitter apparatus. This may lead to improved sensing performance.

However, increasing the size of the set Φ may increase complexity at the receiver apparatus 804 since it may require the receiver apparatus 804 to process more rates. Consequently, there may be a tradeoff between performance and complexity which can be captured by proper design of the set Φ and the associated plurality of sensing codes. In some examples, the set of rates Φ (e.g. the cardinality of the set) and/or the plurality of sensing codes (e.g. the length of each sensing code) may be generated based on one or more of: the number of required sensing codes, a correlation between sensing codes (based on the required sensing KPI), and other possible constraints, such as the out-of-band emission of the sensing signal. The number of required sensing codes may be based on statistics of the number of active sensing transmitter apparatus in a particular area (e.g. the expected or actual number of transmitter apparatus that are to perform sensing in particular area). The correlation between sensing codes may be determined based on a desired (e.g. required or target) sensing performance indicator (e.g. a key performance indicator, KPI). An example of a sensing performance indicator may be an ability to detect the identity of a sensing transmitter based on a received signal. The correlation between sensing codes may, additionally or alternatively, depend on a type of the receiver apparatus 804. For example, a radio-frequency dominant receiver apparatus may experience higher correlation between the sensing codes.

It will be appreciated that the set of rates Φ, the first and second sensing codes and the associated sensing signals shown in FIG. 9 are examples of the set of rates, sensing codes and sensing signals that may be used. In general, any suitable sets of rates and sensing codes (and thus sensing signals) may be used.

Thus, the first transmitter apparatus 802a and the second transmitter apparatus 802b may be assigned respective sensing codes defining respective sensing signals formed from ordered sequences of LFMs. Each of the first transmitter apparatus 802a and the second transmitter apparatus 802b may transmit sensing signals in accordance with their respective sensing codes. Each of the sensing signals may be reflected from a target (not shown) such that a reflected signal (not shown) is received by the receiver apparatus 804. The receiver apparatus 804 may determine a sensing estimate for the target based on the reflected signal and the plurality of sensing codes.

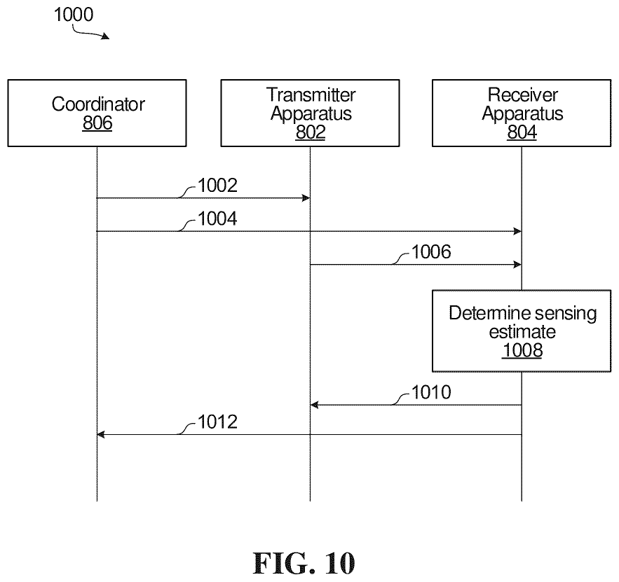

An example implementation of this is described in more detail with respect to FIG. 10, which shows a method 1000 performed by the sensing coordinator 806, the first transmitter apparatus 802 and the receiver apparatus 804.

For ease of reference, the first and second transmitter apparatus 802a are represented in FIG. 10 by a single entity, the transmitter apparatus 802. However, it will be appreciated that operations described below with respect to the transmitter apparatus 802 may be performed in respect of (e.g. for and/or by) the first transmitter apparatus 802a separately from the second transmitter apparatus 802b, and vice-versa.

The method 1000 may begin with the sensing coordinator 806 determining the set of rates Φ. The sensing coordinator 806 may determine the set of rates based on one or more of the following: the number of required sensing codes (e.g. the number of transmitter apparatus 802), a correlation between sensing codes (e.g. based on target sensing performance) and an expected out-of-band emission of a sensing signal formed from a sensing code based on the set of rates. It will be appreciated that there are many ways in which the set of rates may be designed. Specific designs may lead to less complex algorithms and architectures at the receiver apparatus 804. In particular examples, the rates may be selected such that the correlation of among LFMs corresponding to the rates in the set Φ is low. This may be referred to as selecting the rates to minimize the correlation between LFMs. The resulting set of LFMs may be referred to as a semi-orthogonal set of LFMs. A set of semi-orthogonal LFMs may lead to simpler architectures at the receiver apparatus 804. Thus, each sensing code may comprise (e.g. consist of) an ordered sequence of rates in which each rate belongs to the set Φ.

The sensing coordinator 806 may determine the plurality of sensing codes based on the set of rates. Each sensing code may be distinct. The sensing coordinator 806 may map the rate set Φ to a subset of real number alphabets (e.g. Φ→C⊂ [symbol] , in which the alphabets, or sensing codes, belong to the set C). In particular examples, each of the rates may be an integer. Thus the sensing coordinator 806 may map the rate set Φ to a subset of integer alphabets (e.g. Φ→C⊂ [symbol] ).

The sensing coordinator 806 may determine the plurality of sensing codes based on one or more of the following: the number of transmitter apparatus, a sensing signal duration (e.g. a number of symbols that each sensing signal should occupy), a target number of discontinuities in the sensing signal, an out-of-band emission target, etc. It may be particularly advantageous to determine the plurality of sensing codes based on a target number of discontinuities (e.g. by seeking to minimize the number of discontinuities in each sensing signal corresponding to the sensing codes) because reducing the number of discontinuities in the time-frequency representation of a sensing signal may reduce out-of-band emissions. This allows for enlarging the possibilities for multiple access whilst minimizing out-of-band emissions.

Thus, the sensing coordinator 806 may determine the set of rates and the plurality of sensing codes. In embodiments in which the sensing coordinator 806 comprises a TRP or a core network node, this may be referred to as the network creating the sensing codebook.

In other examples, sensing coordinator 806 might not need to determine the set of rates and/or the plurality of sensing codes. For example, the set of rates and/or the plurality of sensing codes may be preconfigured. Thus, the plurality of sensing codes may be retrieved from a memory of the sensing coordinator 806.

The sensing coordinator 806 may select the respective sensing codes for the transmitter apparatus 802 from the plurality of sensing codes. The sensing coordinator 806 may thus assign sensing codes to each of the transmitter apparatus 802. That is, the sensing coordinator 806 may select the first sensing code for the first transmitter apparatus 802a and the second sensing code for the second transmitter apparatus 802b. Alternatively, the sensing coordinator 806 might not select the sensing codes for one or both of the first and second transmitter apparatus 802a, 802b from the plurality of sensing codes. For example, the first transmitter apparatus 802a may already be assigned its particular sensing code. The sensing coordinator 806 may, for example, receive the sensing code for the first transmitter apparatus 802a from another device (e.g. from a base station that was previously connected to the first transmitter apparatus 802a).

In step 1002, the sensing coordinator 806 transmits, to each of the transmitter apparatus 802, an indication of the respective sensing code. The indication may be transmitted using dynamic signaling. For example, the indication may be transmitted in downlink control information (DCI). The indication may be transmitted using semi-static signaling. The indication may be transmitted in a Radio Resource Control (RRC) message or a Medium Access Control (MAC) message, e.g. in a MAC Control Element (MAC-CE). This may be particularly appropriate in examples in which the transmitter apparatus 802 comprise an electronic device. In other examples, the indication may be transmitted using a backhaul signal. This may be particularly appropriate in examples in which the transmitter apparatus 802 comprise a TRP.

The sensing coordinator 806 may, in step 1002, transmit the sensing codes to the transmitter apparatus 802. Alternatively, the sensing coordinator 806 may indicate the sensing codes to the transmitter apparatus 802 without explicitly transmitting the sensing codes.

In particular examples, each sensing code in the plurality of sensing codes may be assigned a unique identifier or index. The sensing coordinator 806 may thus transmit, to each of the transmitter apparatus 802, a respective unique identifier for the respective sensing code in step 1002. In an example, each sensing code may be assigned an integer (e.g. a natural number) that uniquely identifies that particular sensing code. The sensing coordinator 806 may, in step 1002, transmit the respective integer to each of the transmitter apparatus 802. For example, the sensing coordinator 806 may transmit the number 1 to the first transmitter apparatus 802a to indicate the first sensing code to the first transmitter apparatus 802a and the sensing coordinator 806 may transmit the number 2 to the second transmitter apparatus 802b to indicate the second sensing code to the second transmitter apparatus 802b.

In some examples, one or more of the transmitter apparatus 802 may obtain its respective sensing code using a mathematical formula or look-up table (LUT). The look-up table may comprise, for example, identifiers for each the transmitter apparatus 802 and may indicate, for each of the identified transmitter apparatus 802, the respective sensing code. The formula may comprise a relationship between a characteristic of the respective transmitter apparatus 802 (e.g. an identifier of the transmitter apparatus or an identity of a sensing session) and the respective sensing code. The sensing coordinator 806 may, in step 1002, transmit the formula and/or look-up table to the transmitter apparatus 802. The sensing coordinator 806 may, for example, broadcast the formula and/or look-up table. The broadcast may be received by each of the transmitter apparatus 802. Each of the transmitter apparatus 802 may determine its assigned sensing code based on the received formula and/or look-up table.

In step 1004, the sensing coordinator 806 transmits an indication of the plurality of sensing codes to the receiver apparatus 804. The plurality of sensing codes may be specific to a particular region (e.g. the plurality of sensing codes may only include sensing codes for transmitter apparatus in a particular region). In some examples, the plurality of sensing codes may be a subset of a larger set of sensing codes. That is, the sensing coordinator 806 may indicate only a portion of the larger set of sensing codes that is specific to the transmitter apparatus in a given region. The plurality of sensing codes may indicate (e.g. may include) a mapping (or assignment) of sensing codes to transmitter apparatus. For example, the sensing coordinator 806 may in step 1004, transmit a look-up table to the receiver apparatus 804, in which the look-up table indicates the sensing codes for each of the transmitter apparatus 802. The look-up table may, for example, map an identifier of each of the transmitter apparatus 802 (or a sensing session e.g. of the transmitter apparatus 802) to its respective sensing code. In another example, the sensing coordinator 806 may in step 1004, transmit a formula and identifier for each of the transmitter apparatus 802 to the receiver apparatus 804, in which the formula and the identifier may be used to determine the sensing code for each of the transmitter apparatus 802.

The sensing coordinator 806 may transmit the indication of the plurality of sensing codes in using semi-static signaling. This may be particularly appropriate when the sensing coordinator 806 indicates only a portion of a larger set of sensing codes. The sensing coordinator 806 may transmit the indication of the plurality of sensing codes in an RRC message or a MAC message (e.g. in a MAC-CE). This may be particularly appropriate in examples in which the receiver apparatus 804 comprises an electronic device. In other examples, the indication may be transmitted using a backhaul signal or an integrated access and backhaul (IAB) signal. This may be particularly appropriate in examples in which the receiver apparatus 804 comprises a TRP.

In some examples, step 1004 may be omitted. For example, the receiver apparatus 804 may retrieve the plurality of sensing codes and/or the mapping from memory.

In step 1006, each of the transmitter apparatus 802 transmits a respective sensing signal in accordance with its respective sensing code. Thus, the first transmitter apparatus 802a may transmit a first sensing signal according to the first sensing code and the second transmitter apparatus 802b may transmit a second sensing signal according to the second sensing code. Each sensing signal includes (e.g. consists of) an ordered sequence of LFMs, in which each of the LFMs has a slope specified by a corresponding rate specified in the sensing code. Each sensing signal may thus be a particular instance of the generalized LFM-based waveform described above (e.g. in respect of FIG. 7), in which the rates of the LFMs forming the waveform are specified by the sensing code. Thus, the first and second transmitter apparatus 802a, 802b transmit distinct sensing signals in accordance with their respective sensing codes.

It will be appreciated that, in some examples, there may be a one-to-one correspondence between the rates in the sensing code and the LFMs in the sensing signal. For example, the sensing code is (α₁, α₂), may correspond to a sensing signal consisting of a first LFM with slope α₁ followed by a second LFM with slope α₂. In other examples, there might not be a one-to-one correspondence between the rates in the sensing code and the LFMs in the sensing signal. This may be particularly appropriate when the sensing signal includes a repetition of one or more LFMs (e.g. according to a repetition pattern) as described in more detail below. For example, the sensing code (α₁, −α₁) associated with a repetition pattern with a repetition period of 2 symbols and 4 repetitions may correspond to a sensing code formed from four triangle waves, in which each triangle wave is formed from a first chirp with slope α₁ and a duration of one symbol, and a second chirp with slope −α₁ and a duration of one symbol.

The transmitter apparatus 802 may transmit the sensing signals using overlapping time-frequency resources. For example, the first transmitter apparatus 802a and the second transmitter apparatus 802b may transmit their respective sensing signals using the same time-frequency resources. In other examples, each of the transmitter apparatus 802 may transmit the sensing signals using different time-frequency resources. Thus, the techniques described herein may be used instead of, or in combination with, multiplexing in the time and/or frequency domain.

The transmitter apparatus 802 may transmit the sensing signals towards one or more targets to be sensed (omitted from FIGS. 8 and 10 for simplicity). The first and second transmitter apparatus 802a, 802b may transmit sensing signals towards the same one or more targets or towards one or more different targets. The one or more targets may be anything detectable via sensing (e.g. detectable with radio signal-based sensing). The one or more targets may be referred to as one or more objects. The one or more targets may comprise, for example, one or more of: a vehicle (e.g. a car, bus, train etc.), a communication device, a person, etc. The communication device may comprise a network node (e.g. a base station or TRP, such as any of the TRPs 170a-170b described above) or an electronic device (e.g. any of the electronic devices 110 described above), for example.

One or more of (e.g. both of) the transmitter apparatus 802 may transmit its respective sensing signal using one or more beams, in which the one or more beams are based (e.g. determined or selected based on) an estimated (e.g. predicted) location of the one or more targets. In another example, one or more of (e.g. both of) the transmitter apparatus 802 may broadcast its respective sensing signal.

The sensing signals reflect from the one or more targets. The receiver apparatus 804 receives a signal comprising the reflections of the sensing signals. That is, the receiver apparatus 804 receives a signal comprising a first reflection of the first sensing signal transmitted by the first transmitter apparatus 802a and a second reflection of the second sensing signal transmitted by the second transmitter apparatus 802b. The reflections of the first and second sensing signals may overlap in time and/or frequency when they are received at the receiver apparatus 804. The received signal may be referred to as a combined signal since it includes multiple reflections. The receiver apparatus 804 may thus receive echoes of the sensing signals transmitted by the first and second transmitter apparatus 802a, 802b, in which the echoes are reflected from the one or more targets.

In step 1008, the receiver apparatus 804 determines sensing estimates for the one or more targets based on the plurality of sensing codes and the received signal (e.g. based on the received reflections of the sensing signals). As the received signal includes reflections of signals transmitted by multiple transmitter apparatus, the receiver apparatus 804 may use the plurality of sensing codes to demultiplex (e.g. distinguish) the sensing signals transmitted by the different transmitter apparatus.

The sensing estimate for a particular target may include, for example, one or more of: the location of the target (e.g. a distance or range between the target and the receiver apparatus 804 and/or the transmitter apparatus 802), a direction to the target (e.g. an angle from the receiver apparatus 804), an orientation of the target, and a movement (e.g. a speed, a direction of movement and/or an acceleration) of the target (e.g. relative to any movement of the receiver apparatus 804).

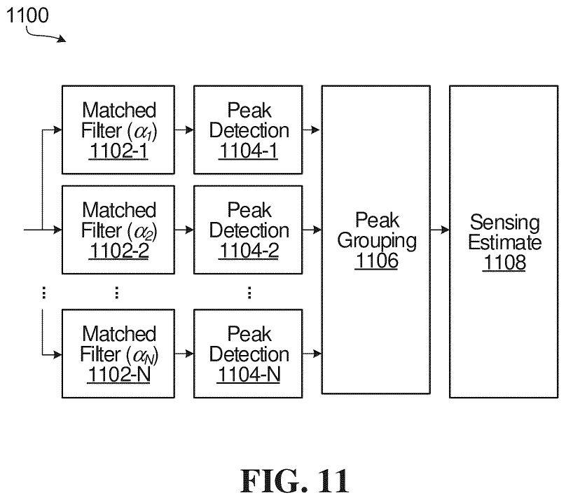

In order to determine sensing estimates based on the received reflected signal(s), the receiver apparatus 804 may detect a particular reflection of a particular sensing signal in the received signal and, based on the sensing code of the particular sensing signal, identify which transmitter apparatus transmitted the particular sensing signal. The sensing estimate may be determined based on the identity of the particular transmitter apparatus. For example, the identity of the particular transmitter apparatus may be used to determine, for example, a location of the transmitter apparatus, movement of the transmitter apparatus etc., which may then be used to determine the sensing estimate. It will be appreciated that there are many ways in which the receiver apparatus 804 may isolate a particular reflection from the received signals and identify the associated transmitter apparatus. One example method 1100 is described below in respect of FIG. 11.

In step 1010, the receiver apparatus 804 transmits the sensing estimates to the respective transmitter apparatus 802. That is, the receiver apparatus 804 may transmit the sensing estimate for the first sensing signal transmitted by the first transmitter apparatus 802a to the first transmitter apparatus 802a and/or the receiver apparatus 804 may transmit the sensing estimate for the second sensing signal transmitted by the second transmitter apparatus 802b to the second transmitter apparatus 802b. In some embodiments, step 1010 may be omitted.

In step 1012, the receiver apparatus 804 transmits the sensing estimates to the sensing coordinator 806. That is, the receiver apparatus 804 may transmit the sensing estimate for the first sensing signal transmitted by the first transmitter apparatus 802a to the sensing coordinator 806 and/or the receiver apparatus 804 may transmit the sensing estimate for the second sensing signal transmitted by the second transmitter apparatus 802b to the sensing coordinator 806. In some embodiments, step 1012 may be omitted.

According to the method 1000, each transmitter apparatus may be assigned a distinct ordered sequence of rates, referred to as a sensing code or sensing codeword, forming its sensing signal. Consequently, different transmitter apparatus can be differentiated by their assigned sequence of rates (e.g. by their sensing code). This allows the sensing transmitter apparatus to use the same or overlapped time-frequency resources for sending signals because the receiver apparatus can separate the reflections of sensing signals transmitted by different transmitter apparatus based on their respective sensing codes. This provides a large number of degrees of freedom for facilitating sensing multiple access.

### Monostatic Sensing

In the method 1000, the sensing signals are transmitted by the transmitter apparatus 802 and reflections of the sensing signals are received by a different apparatus, the receiver apparatus 804. This is an example of multi-static sensing or bi-static sensing. In other embodiments, monostatic sensing may be used, such that the same apparatus transmits the sensing signal and receives the reflection of the sensing signal. Thus, in some examples, the operations described above in respect of the receiver apparatus 804 may be performed by the transmitter apparatus 802 or the operations described above in respect of one of the transmitter apparatus 802 may be performed by the receiver apparatus 804. In these examples, steps 1002 and 1004 may be performed as a single step. For example, the apparatus performing monostatic sensing may receive the plurality of sensing codes from the coordinator 806 and an indication of which sensing code it is to use in a single message.

In some embodiments, a combination of monostatic and bistatic sensing may be used. For example, the first transmitter apparatus 802a may receive reflections of sensing signals transmitted by both the first transmitter apparatus 802a and the second transmitter apparatus 802b. That is, the first transmitter apparatus 802a may both perform monostatic sensing (in respect of the sensing signal transmitted by the first transmitter apparatus 802a) and perform bistatic sensing (in respect of the sensing signal transmitted by the second transmitter apparatus 802b).

### Obtaining the Sensing Code

In the description of the method 1000 above, each of the transmitter apparatus 802 receives an indication of its sensing code from the sensing coordinator 806. In other embodiments, one or more of the transmitter apparatus 802 may obtain its sensing code through other means. For example, at least one of the transmitter apparatus 802 may retrieve its sensing code from memory. In another example, at least one of the transmitter apparatus 802 may select its sensing code from the plurality of sensing codes. The particular transmitter apparatus 802 may receive the plurality of sensing codes (e.g. from the sensing coordinator 806) or may retrieve the plurality of sensing codes from memory, for example. The particular transmitter apparatus 802 may indicate its selected sensing code to one or more other apparatus (e.g. to the receiver apparatus 804 and/or another transmitter apparatus).

### Configuration Parameters

The sensing coordinator 806 may, in step 1002, additionally indicate one or more configuration parameters to the transmitter apparatus 802. The indication may be transmitted using semi-static signaling. The indication may be transmitted in an RRC message or a MAC message (e.g. in a MAC-CE). The indication of the one or more configuration parameters may be sent to the transmitter apparatus 802 in the same messages or a different message to the indications of the sensing codes.

Additionally or alternatively, the sensing coordinator 806 may, in step 1004, indicate one or more configuration parameters to the receiver apparatus 804. The indication may be transmitted in an RRC message or a MAC message (e.g. in a MAC-CE). The indication of the one or more configuration parameters may be sent to the receiver apparatus 804 in the same message or a different message to the indication of the plurality of sensing codes.

The transmitter apparatus may, in step 1006, transmit the sensing signal in accordance with the one or more configuration parameters and the sensing code.

The one or more configuration parameters may characterize a construction of the particular sensing signal based on the sensing code indicated in step 1002. That is, the one or more configuration parameters may indicate, to the transmitter apparatus 802 and/or the receiver apparatus 804, how to construct (e.g. form) the particular sensing signal based on the sensing code. The indication of the one or more configuration parameters may be sent in the same message(s) described above in respect of steps 1002 and/or 1004, or in a different message.

The one or more configuration parameters may comprise one or more of: a start time of a first LFM in the ordered sequence of LFMs, a starting frequency of at least one LFM in the ordered sequence of LFMs; and a bandwidth of the sensing signal.

In some examples, the sensing signal may comprise a repetition of the ordered sequence of LFMs in time and/or frequency. Thus, for example, a sensing signal having a sensing code (α₁, α₂, α₃) which is repeated once in time may comprise a sequence of LFMs having respective rates (α₁, α₂, α₃, α₁, α₂, α₃) The repetition of the ordered sequence of LFMs may be in accordance with any suitable repetition pattern. The repetition pattern may, for example, specify an interval or gap (e.g. in time and/or frequency) between repetitions, a number of repetitions etc. In particular examples, the one or more configuration parameters may comprise a characteristic (e.g. the interval between repetitions, the number of repetitions etc.) of the repetition pattern.

In other embodiments, the indication of the configuration parameters to the transmitter apparatus 802 and/or the receiver apparatus 804 may be omitted. For example, the transmitter apparatus 802 and/or the receiver apparatus 804 may retrieve the configuration parameters from memory. In another example, the transmitter apparatus 802 may determine the configuration parameters and indicate the configuration parameters to the receiver apparatus 804.

### Receiving a Sensing Signal

In the method 1000 described above, each of the transmitter apparatus 802 transmits a respective sensing signal and the sensing signals are reflected from one or more targets before they are received at the receiver apparatus 804. In other embodiments, each of the transmitter apparatus 802 may transmit a respective sensing signal directly to the receiver apparatus 804. The transmission of the sensing signals may be performed in accordance with step 1006 described above, except that the sensing signals may be transmitted towards the receiver apparatus 804, rather than the one or more targets. The receiver apparatus 804 may, in step 1008, determine sensing estimates for each of the transmitter apparatus 802 based on their respective sensing signals. That is, the transmitter apparatus 802 may be the targets to be sensed by the receiver apparatus 804. This may be used to, for example, estimate the range between one or more of the transmitter apparatus 802 and the receiver and/or a velocity of one or more of the transmitter apparatus 802.

In general, the receiver apparatus 804 may, in step 1006, receive a sensing signal for a target, in which the sensing signal may have been transmitted by the target (e.g. the transmitter apparatus 802 may be the target) or the sensing signal may have been transmitted by a transmitter apparatus (e.g. the transmitter apparatus 802) and reflected by one or more targets.

### Methods for Sensing Multiple Targets

In the method 1000 described above, the receiver apparatus 804 determines sensing estimates for one or more targets based on reflections of sensing signals from the one or more targets. In some embodiments, only one reflection of a particular sensing signal may be received by the receiver apparatus 804. The receiver apparatus 804 may thus, in step 1008, determine a sensing estimate for the target that reflected the particular sensing signal.

In other embodiments, a particular sensing signal may be reflected from more than one target, or may be reflected by a target more than once (e.g. in the case of larger targets). Thus, for example, the first transmitter apparatus 802 may, in step 1006, transmit the first sensing signal and the receiver apparatus 804 may receive a first reflection of the first sensing signal and a second reflection of the first sensing signal. The first and second reflections may have been reflected by the same target (e.g. different parts of the same target). The receiver apparatus 804 may thus, in step 1008, determine a sensing estimate for the same target based on the first reflection and the second reflection. Alternatively, the first reflection may have been reflected by a first target and the second reflection may have been reflected by a second target, different to the first target. The receiver apparatus 804 may thus, in step 1008, determine a sensing estimate for the first target based on the first reflection and a sensing estimate for the second target based on the second reflection.

It will be appreciated that, when multiple reflections are received at the receiver apparatus 804, they may interfere with one another in time and frequency. In some embodiments, one or more processes (e.g. algorithms) may be used to cancel such interference. This interference may be referred to as multi-path or multi-target interference. In an example, the receiver apparatus 804 may use the space-alternating generalized expectation-maximization (SAGE) process to iteratively detect, estimate, and cancel multi-path components from the received signal.

### Determining a Sensing Estimate

FIG. 11 is a block diagram showing an example method 1100 performed by a receiver apparatus for determining a sensing estimate based on a received signal and a plurality of sensing codes. The receiver apparatus may be the receiver apparatus 804, for example. The plurality of sensing codes is defined as described above in respect of FIGS. 8-9. The received signal includes a reflection of a sensing signal from a target, in which the sensing signal has been transmitted by a transmitter apparatus. The transmitter apparatus may be the first transmitter apparatus 802a or the second transmitter apparatus 802b, for example. In some examples, the received signal may include more than one reflection (e.g. multiple reflections of the same sensing signal, such as from multiple targets, and/or reflections of different sensing signals from the same or different targets).

As described above, the plurality of sensing codes are based on a set of rates Φ comprising N unique rates. That is, the plurality of sensing codes includes N distinct rates. In the method 1100, the receiver apparatus 804 uses one branch for each of the available rates in the set Φ. As shown in FIG. 11, each branch i for i=1,2, . . . , N includes a respective matched filtering step, 1102-i and an envelope peak detection step, 1104-i.

In each matched filtering step 1102-i, the receiver apparatus 804 correlates the received signal with an LFM having a respective rate α₁ from the set of rates Φ to obtain a filtered signal. Thus, for example, in the first matched filter step 1102-1 the received signal may be correlated with an LFM with rate α₁ and in the second matched filtering step 1102-2, the received signal may be correlated with an LFM with rate α₂. This may alternatively be referred to a pulse compression.

In each peak detection step 1104-i, the receiver apparatus 804 identifies any peaks in the filtered signals. Together, the matched filtering steps 1102-1, 1102-2, . . . , 1102-N and the peak detecting steps 1104-1, 1104-2, . . . , 1104-N may be used to detect particular LFMs in the received signal. Thus, for example, a peak detected by the first peak detection step 1104-1 may indicate that an LFM with rate ajis present in the received signal. Matched filtering and peak detection may thus be used to reveal the existence of an LFM in the received signal at the receiver apparatus 804.

In the peak grouping step 1106, the receiver apparatus 804 groups the detected LFMs into one or more detected signals based on the plurality of sensing codes. Since each sensing code comprises an ordered sequence of rates defining a particular sensing signal, the plurality of sensing codes effectively indicate which LFMs belong to which sensing signals. Therefore, the receiver apparatus 804 can reconstruct each reflection of a sensing signal that is present in the received signal based on the detected LFMs and the plurality of sensing codes. In some embodiments, each sensing code in the plurality of sensing codes may be assigned to a respective transmitter apparatus. As such, the receiver apparatus 804 may identify the transmitter apparatus transmitted the sensing signal based on the one or more detected signals and the plurality of sensing codes (e.g. based on a mapping between the sensing codes and one or more transmitter apparatus).

In some examples, the peak grouping step 1106 may use additional information to group the detected LFMs into one or more detected signals. Any delay and/or Doppler shifting of LFMs transmitted by the same transmitter apparatus (e.g. transmitted as part of the same sensing signal) should be the same. Thus, in some embodiments, the peak grouping step 1106 may involve grouping detected LFMs into one or more sensing signals based on a delay of at least one of the LFMs and/or a Doppler shift (e.g. a change in frequency) of one or more of the LFMs. Delay and Doppler shift are examples of sensing parameters that may be determined based on the LFMs. Thus, in general, the detected LFMs may be grouped based on one or more sensing parameters determined based on the detected LFMs.

Any suitable techniques may be used to determine the delay and/or the Doppler shift of a particular LFM. For example, the delay and/or the Doppler shift may be determined based on the matched filtering described above. In some examples, the delay and/or Doppler shift of an LFM may be determined based on a measurement of a beat frequency of a filtered signal. Additionally or alternatively, de-chirping, which may also be referred to as de-chirp processing, may be performed using the rates in the set Φ to determine the delay and/or Doppler shift. De-chirping involves multiplying a received signal (e.g. a signal that has been transmitted over a wireless channel) by an LFM with a particular rate. De-chirping processing can be accomplished with low complexity and has some advantages. For example, it can reduce the interference of other LFMs with other rates that may be included in the received signal.

In some examples, the peak grouping step 1106 may also involve using some or all of the one or more configuration parameters described above to group the detected LFMs into one or more detected signals. The receiver apparatus 1106 may retrieve the one or more configuration parameters from memory and/or may have received the one or more configuration parameters (e.g. with the plurality of codes in step 1004).

After the detected LFMs are grouped into one or more sensing signals, the receiver apparatus 804 may identify, for each of the one or more sensing signals, the transmitter apparatus that transmitted the respective sensing signal. The receiver apparatus 804 may identify a particular transmitter apparatus based on its sensing code. For example, the receiver apparatus may, in step 1106, group detected LFMs together to detect that the received signal includes a particular sensing signal. The receiver apparatus 804 may determine the sensing code that corresponds to the particular sensing signal and, based on the determined sensing code, identify the transmitter apparatus that transmitted the particular sensing signal. The receiver apparatus 804 may, for example, compare the determined sensing code to a look-up table (e.g. any of the look-up tables described above) in order to identify the particular transmitter apparatus. In another example, the receiver apparatus 804 may use a mathematical formula to determine an identifier of the particular transmitter apparatus 802a based on the determined sensing code. The mathematical formula may be an inverse of the mathematical formula for determining a sensing code described above. Thus, the receiver apparatus 804 may use a dictionary of sensing codes and corresponding sensing transmitter apparatus identifiers in the grouping.

In sensing estimation step 1108, the receiver apparatus 804 determines a sensing estimate based on the one or more sensing signals obtained in the peak grouping step 1106. The sensing estimate may be defined as described above in respect of step 1008. The sensing estimate may be determined based on the identity of the transmitter apparatus (e.g. based on an identifier of the transmitter apparatus or an identifier of a sensing session) that transmitted the one or more sensing signals. The identity of a transmitter apparatus may be used by the receiver apparatus 804 to determine, for example, a location of the transmitter apparatus, movement of the transmitter apparatus etc., which may then be used to determine the sensing estimate. The receiver apparatus 804 may retrieve the location of the transmitter apparatus from memory based on the identity of (e.g. an identifier of) the transmitter apparatus, for example.

According to the method 1100, a sensing estimate may be determined based on a received signal and the plurality of sensing codes. As the received signal may include reflections of sensing signals transmitted by more than one transmitter apparatus, multiple LFMs with different rates may be detected through various branches at the receiver apparatus. The receiver apparatus may then identify which LFMs belong to the same sensing signal (e.g. belong to the sensing signal of the same transmitter apparatus). To this end, the receiver apparatus may group the detected LFMs. The grouping may use the knowledge of the plurality of sensing codes (e.g. the sensing codebook) and may optionally use the knowledge that LFMs transmitted by the same transmitter apparatus may experience the same delay. The delay of a particular LFM may be used to separate it from other LFMs belonging to a sensing signal transmitted by another transmitter apparatus. After grouping the LFMs, the receiver apparatus may form the sensing code of the transmitter apparatus whose sensing signals are received by the receiver apparatus. The receiver apparatus may identify the transmitter apparatus using any known mapping between the sensing codes (or an indication of the sensing code) and identifiers the of the transmitter apparatus (e.g. according to a look-up table or formula). The receiver apparatus may estimate the sensing estimate for each transmitter apparatus. As described in the method 1000, the receiver apparatus may transmit the sensing estimate(s) to the transmitter apparatus and/or other nodes (e.g. the sensing coordinator 806). As this example method 1100 is RF-dominant (i.e., primarily executed in the RF domain or in RF hardware, apart from the baseband domain or baseband hardware), it may minimize complexity and power consumption typically associated with baseband-dominant or wholly-baseband processing methods.

In the specific example of method 1100, the receiver apparatus 804 uses matched filtering, peak detecting, and peak grouping to process a received signal in order to determine, in step 1108, a sensing estimate. In other embodiments, other techniques may be used in place of some or all of these processing steps. In one example illustrative of a variation of the method 1100, instead of performing the matched-filtering steps 1102-i, the receiver apparatus 804 may use de-chirping and beat frequency detection to obtain filtered signals. The de-chirping and beat frequency detection may be performed as described above. De-chirping may be performed using the rates in the set Φ.

### Example Methods

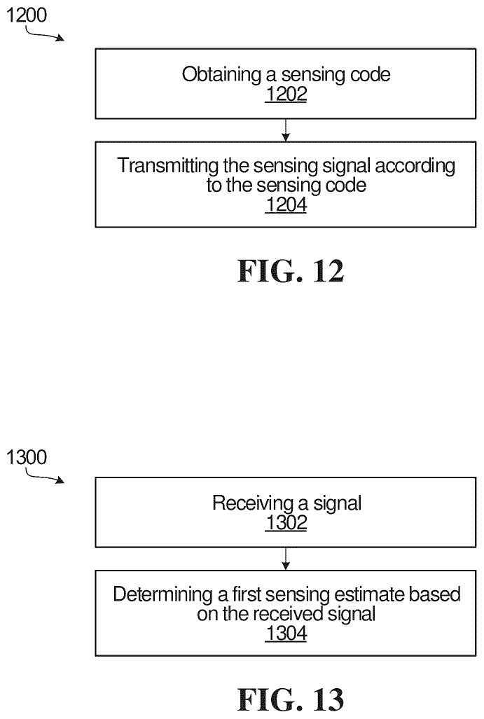

FIG. 12 shows a flowchart of a method 1200 according to embodiments of the disclosure. The method 1200 may be performed by an apparatus (e.g. a device, a chip, a processor). The method 1200 may be performed by a transmitter apparatus, such as the first transmitter apparatus 802a and/or the second transmitter apparatus 802b. The method 1200 may be performed by a sensing device or node. The method 1200 may be performed by a communication device, such as a network node or an electronic device. In some embodiments, the method 1200 may be performed by a processor, such as a processor of a transmitter apparatus (e.g. of the either of the transmitter apparatus 802 described above). In general, the method 1200 may be performed by any suitable apparatus, or a processor of the apparatus. In some embodiments, the method 1200 may be distributed across (e.g. performed by) more than one apparatus.

The method may involve, in step 1202, obtaining a sensing code. The sensing code may include an ordered sequence of rates. The sensing code may alternatively be referred to as a code, codeword, sensing codeword, sensing signal identifier etc. The rates may alternatively be referred to as slopes, gradients etc.

Step 1202 may involve receiving an indication of the sensing code (e.g. from a sensing coordinator, such as the sensing coordinator 806). The indication may be received using dynamic signaling. For example, the indication may be received in downlink control information (DCI). The indication of the sensing code may be received using semi-static signaling. The indication of the sensing code may be received in an RRC message or a MAC message (e.g. in a MAC-CE). Step 1202 may be performed in accordance with step 1002, for example.

Step 1202 may involve selecting the sensing code from a plurality of sensing codes. The plurality of sensing codes may be referred to as a dictionary, a codebook, a sensing dictionary, a sensing codebook etc. Each of the plurality of sensing codes may include a respective ordered sequence of rates. Each of the plurality of sensing codes may be unique (e.g. distinct). The plurality of sensing codes may be retrieved from memory or received from elsewhere (e.g. as indicated by a sensing coordinator, such as the sensing coordinator 806), for example. The plurality of sensing codes may be received using semi-static signaling. The plurality of sensing codes may be received in an RRC message or a MAC message (e.g. in a MAC-CE).

The method 1200 may involve, in step 1204, transmitting a sensing signal according to the sensing code. The sensing signal may include an ordered sequence of LFMs. The LFMs may be referred to as chirps. The ordered sequence may also be referred to as a series. Each of the LFMs in the ordered sequence of LFMs may have a slope (e.g. a gradient) specified by a corresponding rate in the ordered sequence of rates. Transmitting the sensing signal may comprise, or instead involve, outputting the sensing signal. Transmitting or outputting the sensing signal may involve, for example, transmitting or outputting the sensing signal from a first processor, module, or hardware element in an apparatus, to a second, downstream processor, module, or hardware element in the apparatus.

The sensing signal may include a repetition of the ordered sequence of LFMs in time and/or frequency. The repetition may be in accordance with a repetition pattern.

The method 1200 may also involve obtaining one or more configuration parameters. The one or more configuration parameters may be retrieved from memory, for example. Alternatively, the method 1200 may involve receiving an indication of the one or more configuration parameters. The one or more configuration parameters may be received in the same message as the indication of the sensing code or the plurality of codes, characterizing a construction of the sensing signal based on the ordered sequence of rates.

The one or more configuration parameters may comprise one or more of: a start time of a first LFM in the ordered sequence of LFMs (or, equivalently, an end time of the last LFM in the ordered sequence of LFMs), a starting frequency of at least one LFM in the ordered sequence of LFMs (or, equivalently, an end frequency of at least one LFM in the ordered sequence of LFMs), a bandwidth of the sensing signal (or equivalently, the minimum and maximum frequencies of the sensing signal) and a characteristic of any repetition pattern. The characteristic of the repetition pattern may include one or more of: a periodicity of transmission, denoted by \tilde{T}ᵢ, \tilde{F}ᵢ, a number of repetitions, a gap or interval between repetitions (e.g. a time and/or frequency interval between the end of one repetition and the beginning of the next repetition).

The method 1200 may also involve receiving a signal comprising a reflection of the sensing signal from a first target. The method 1200 may also involve determining, based on the received signal and a plurality of sensing codes including the sensing code, a sensing estimate for the first target. The sensing estimate may be determined in accordance with step 1008 and/or the method 1100 described above, for example.

In a further aspect, an apparatus configured to perform the method 1200 is also provided. The apparatus may include a processor and a memory (e.g. a non-transitory processor-readable medium). The memory stores instructions (e.g. processor-readable instructions) which, when executed by a processor of an apparatus, cause the apparatus to perform the method 1200. In another aspect, the memory may be provided (e.g. separate to the apparatus).

FIG. 13 shows a flowchart of a method 1300 according to embodiments of the disclosure. The method 1300 may be performed an apparatus (e.g. a device, a chip, a processor). The method 1300 may be performed by a receiver apparatus, such as receiver apparatus 804. The method 1300 may be performed by a sensing device or node. The method 1300 may be performed by a communication device, such as a network node or an electronic device. In some embodiments, the method 1300 may be performed by a processor, such as a processor of a receiver apparatus (e.g. of the receiver apparatus 804 described above). In general, the method 1300 may be performed by any suitable apparatus, or a processor of the apparatus. In some embodiments, the method 1300 may be distributed across (e.g. performed by) more than one apparatus.

The method 1300 may involve, in step 1302, receiving a signal comprising a first sensing signal for a first target. The first target may comprise any of the one or more targets to be sensed described above in respect of the method 1000. The first sensing signal may include a first ordered sequence of LFMs. The LFMs may be referred to as chirps. The first sensing signal may have been transmitted by a first transmitter apparatus (e.g. the first transmitter apparatus 802a).

The first sensing signal may have been transmitted by the first target. That is, the first sensing signal may be received from the first target (e.g. received directly from the first target). Alternatively, the first sensing signal may be received after having been transmitted by a particular transmitter apparatus (e.g. the first transmitter apparatus 802a) and reflected by the first target. This may be the same or analogous to the description of the receiver apparatus 804 receiving a signal including reflections of sensing signals from one or more targets in the method 1000. Thus, step 1302 may involve receiving a signal comprising a first reflection of a first sensing signal from the first target, in which the first sensing signal was transmitted by a particular transmitter apparatus (e.g. the first transmitter apparatus 802a).

The method 1300 may involve, in step 1304, determining a first sensing estimate for the first target. The first sensing estimate may include, for example, one or more of: the location of the target, a direction to the target, an orientation of the target and a movement of the target. The first sensing estimate may be determined based on the received signal and a plurality of sensing codes. A first sensing code in the plurality of sensing codes may include a first ordered sequence of rates, in which each of the LFMs in the first ordered sequence of LFMs has a slope specified by a corresponding rate in the first ordered sequence of rates.

Determining the first sensing estimate may involve identifying the apparatus that transmitted the first sensing signal (e.g. the particular transmitter apparatus or the target apparatus) based on the detection of the first sensing signal in the received signal, and determining the first sensing estimate based on the identity of the apparatus that transmitted the first sensing signal. The identity of the apparatus that transmitted the first sensing signal may be used to determine, for example, a location, movement etc. of the apparatus that transmitted the first sensing signal, which may then be used to determine the sensing estimate. Identifying the apparatus that transmitted the first sensing signal (e.g. the particular transmitter apparatus or the target apparatus) may involve associating the first sensing code with the first sensing signal in the received signal and identifying the apparatus that transmitted the first sensing signal based on the first sensing code. As each sensing code may be associated with (e.g. uniquely associated with) a particular apparatus, each sensing code may be used to identify a respective apparatus. By associating the first sensing code with the first sensing signal, any sensing parameters (e.g. a delay and/or a Doppler shift) that are determined based on the first sensing signal may be associated with the apparatus that transmitted the first sensing signal, which enables determining a sensing estimate based on the sensing parameters.

The first sensing estimate may be determined in accordance with step 1008 and/or the method 1100 described above, for example.

Each of the plurality of sensing codes may correspond to (e.g. be assigned to or associated with) a respective transmitter apparatus, such as any of the transmitter apparatus 802 described above. In some examples, the plurality of sensing codes may also include a second ordered sequence of rates (e.g. a second sensing code). The received signal may also include a second sensing signal for a second target. The second sensing signal may include a second ordered sequence of LFMs, in which each of the LFMs in the second ordered sequence of LFMs may have a slope specified by a corresponding rate in the second ordered sequence of rates. The method 1300 may also involve determining, based on the second reflection and the plurality of sensing codes, a second sensing estimate for the second target. The first sensing estimate and/or the second sensing estimate may be determined using the method 1100, for example.

The first and second sensing signal may have been transmitted by different transmitter apparatus. For example, the first sensing signal may have been transmitted by the first transmitter apparatus 802a and the second sensing signal may have been transmitted by the second transmitter apparatus 802b. The first sensing code may be associated with (e.g. may identify) the first transmitter apparatus 802a (or a sensing session at the first transmitter apparatus 802a). The second sensing code may be associated with (e.g. may identify) the second transmitter apparatus 802b (or a sensing session at the first transmitter apparatus 802a). Thus, the first and second sensing code may be used to distinguish between sensing signals transmitted by the first and second transmitter apparatus 802a, 802b. The first target may be the same, or different to the second target. Thus, for example, the first and second transmitter apparatus 802a may transmit their respective sensing signals towards the same target or towards different targets.

The first and second sensing signals may have been transmitted by the same transmitter apparatus. For example, the first transmitter apparatus 802a may have transmitted two different sensing signals, in which each of the two different sensing signals was associated with a particular sensing code. The first target may be different to the second target. In some examples, each sensing code may be specific to a particular target. This may allow for distinguishing between sensing signals reflected by different targets but transmitted by the same transmitter apparatus. The method 1300 may also involve receiving the plurality of sensing codes. For example, the method 1300 may involve receiving a plurality of sensing codes and a mapping of each sensing code (e.g. of an indication of each sensing code) to a respective transmitter apparatus. This may be performed in accordance with step 1004 described above, for example. The plurality of sensing codes and/or the mapping may be received using semi-static signaling. The plurality of sensing codes and/or the mapping may be received in an RRC message or a MAC message (e.g. in a MAC-CE). The plurality of sensing codes and/or the mapping may be received in a backhaul signal or an integrated access and backhaul (IAB) signal. In some examples, the method 1300 may comprise obtaining the plurality of sensing codes (and, optionally, the mapping) through other means (e.g. determining the plurality of sensing codes or retrieving the plurality of sensing codes from memory).

In a further aspect, an apparatus configured to perform the method 1300 is also provided. The apparatus may include a processor and a memory (e.g. a non-transitory processor-readable medium). The memory stores instructions (e.g. processor-readable instructions) which, when executed by a processor of an apparatus, cause the apparatus to perform the method 1300. In another aspect, the memory may be provided (e.g. separate to the apparatus).

It should be appreciated that, although the steps of the methods provided herein may be described a particular order, the present disclosure is not limited as such. The skilled person will appreciate that the steps of the methods described herein may be performed in any suitable order, including in an order different to the order explicitly described herein. For example, step 1004 in the method 1000 may be performed before, during or after step 1002. It will also be appreciated that, in some embodiments, some steps of the methods described herein may be omitted. For example, one or more of steps 1002, 1004, 1010 and 1012 may be omitted from the method 1000.

### Closing Remarks

It should be appreciated that one or more steps of the embodiment methods provided herein may be performed by corresponding units or modules. For example, a signal may be transmitted by a transmitting unit or a transmitting module. A signal may be received by a receiving unit or a receiving module. A signal may be processed by a processing unit or a processing module. The respective units/modules may be hardware, software, or a combination thereof. For instance, one or more of the units/modules may be an integrated circuit, such as field programmable gate arrays (FPGAs) or application-specific integrated circuits (ASICs). It will be appreciated that where the modules are software, they may be retrieved by a processor, in whole or part as needed, individually or together for processing, in single or multiple instances as required, and that the modules themselves may include instructions for further deployment and instantiation.

Although a combination of features is shown in the illustrated embodiments, not all of them need to be combined to realize the benefits of various embodiments of this disclosure. In other words, a system or method designed according to an embodiment of this disclosure will not necessarily include all of the features shown in any one of the figures or all of the portions schematically shown in the figures. Moreover, selected features of one example embodiment may be combined with selected features of other example embodiments.

While this disclosure has been described with reference to illustrative embodiments, this description is not intended to be construed in a limiting sense. Numerous modifications and variations of the present disclosure are possible in light of the above teachings. It is therefore to be understood that within the scope of the appended claims, the disclosure may be practiced otherwise than as specifically described herein.

1. A method comprising:
obtaining a sensing code, the sensing code comprising an ordered sequence of rates; and
transmitting a sensing signal in accordance with the sensing code, the sensing signal comprising an ordered sequence of linear frequency modulated signals (LFMs), each LFM in the ordered sequence of LFMs having a corresponding slope specified by a corresponding rate in the ordered sequence of rates.

2. The method of claim 1, wherein the obtaining the sensing code comprises:
receiving an indication of the sensing code.

3. The method of claim 1, wherein the obtaining the sensing code comprises:
selecting the sensing code from a plurality of sensing codes, each sensing code of the plurality of sensing codes comprising a respective ordered sequence of rates.

4. The method of claim 1, further comprising:
receiving an indication of one or more configuration parameters characterizing a construction of the sensing signal based on the ordered sequence of rates,
wherein the transmitting the sensing signal in accordance with the sensing code comprises:
transmitting the sensing signal in accordance with the one or more configuration parameters and the sensing code.

5. The method of claim 1, further comprising:
receiving a signal comprising a reflection of the sensing signal from a first target; and
determining, based on the received signal and a plurality of sensing codes including the sensing code, a sensing estimate for the first target.

6. A method comprising:
receiving a signal comprising a first sensing signal for a first target, the first sensing signal comprising a first ordered sequence of linear frequency modulated signals (LFMs); and
determining, based on the received signal and a plurality of sensing codes, a first sensing estimate for the first target, wherein a first sensing code in the plurality of sensing codes comprises a first ordered sequence of rates, each LFM in the first ordered sequence of LFMs having a corresponding slope specified by a corresponding rate in the first ordered sequence of rates.

7. The method of claim 6, wherein each sensing code of the plurality of sensing codes corresponds to a respective transmitter apparatus.

8. The method of claim 6, wherein the plurality of sensing codes further comprises a second ordered sequence of rates, and wherein the received signal further comprises a second sensing signal for a second target, the second sensing signal comprising a second ordered sequence of LFMs, each LFM in the second ordered sequence of LFMs having a second corresponding slope specified by a second corresponding rate in the second ordered sequence of rates, the method further comprising:
determining, based on the second sensing signal and the plurality of sensing codes, a second sensing estimate for the second target.

9. The method of claim 6, wherein the first sensing signal was transmitted by the first target.

10. The method of claim 6, wherein the first sensing signal is received after having been transmitted by a particular transmitter apparatus and reflected by the first target.

11. An apparatus comprising:
at least one processor; and
a memory storing instructions which, when executed by the at least one processor, cause the apparatus to perform:
obtaining a sensing code, the sensing code comprising an ordered sequence of rates; and
transmitting a sensing signal in accordance with the sensing code, the sensing signal comprising an ordered sequence of linear frequency modulated signals (LFMs), each LFM in the ordered sequence of LFMs having a corresponding slope specified by a corresponding rate in the ordered sequence of rates.

12. The apparatus of claim 11, wherein the obtaining the sensing code comprises:
receiving an indication of the sensing code.

13. The apparatus of claim 11, wherein the obtaining the sensing code comprises:
selecting the sensing code from a plurality of sensing codes, each sensing code of the plurality of sensing codes comprising a respective ordered sequence of rates.

14. The apparatus of claim 11, wherein the apparatus is further caused to perform:
receiving an indication of one or more configuration parameters characterizing a construction of the sensing signal based on the ordered sequence of rates,
wherein the transmitting the sensing signal in accordance with the sensing code comprises:
transmitting the sensing signal in accordance with the one or more configuration parameters and the sensing code.

15. The apparatus of claim 11, wherein the apparatus is further caused to perform:
receiving a signal comprising a reflection of the sensing signal from a first target; and
determining, based on the received signal and a plurality of sensing codes including the sensing code, a sensing estimate for the first target.

16. An apparatus comprising:
at least one processor; and
a memory storing instructions which, when executed by the at least one processor, cause the apparatus to perform:
receiving a signal comprising a first sensing signal for a first target, the first sensing signal comprising a first ordered sequence of linear frequency modulated signals (LFMs); and
determining, based on the received signal and a plurality of sensing codes, a first sensing estimate for the first target, wherein a first sensing code in the plurality of sensing codes comprises a first ordered sequence of rates, each LFM in the first ordered sequence of LFMs having a corresponding slope specified by a corresponding rate in the first ordered sequence of rates.

17. The apparatus of claim 16, wherein each sensing code of the plurality of sensing codes corresponds to a respective transmitter apparatus.

18. The apparatus of claim 16, wherein the plurality of sensing codes further comprises a second ordered sequence of rates, and wherein the received signal further comprises a second sensing signal for a second target, the second sensing signal comprising a second ordered sequence of LFMs, each LFM in the second ordered sequence of LFMs having a second corresponding slope specified by a second corresponding rate in the second ordered sequence of rates, wherein the apparatus is further caused to perform:
determining, based on the second sensing signal and the plurality of sensing codes, a second sensing estimate for the second target.

19. The apparatus of claim 16, wherein the first sensing signal was transmitted by the first target.

20. The apparatus of claim 16, wherein the first sensing signal is received after having been transmitted by a particular transmitter apparatus and reflected by the first target.
